(19) United States
(12) Patent Application Publication
(10) Pub. No.: US 2008/0082541 A1
(43) Pub. Date: Apr. 3, 2008

(54) System and Method for Determining Relationships Between Users of a Network System

(76) Inventors: Aaron Lee Davidson, Auckland (NZ); Gregory Paul Amer, Auckland (NZ); Brendon Roberts, Auckland (NZ)

Correspondence Address: WILMERHALE/BOSTON, 60 STATE STREET, BOSTON, MA, 02109, US

(21) Appl. No.: 10/564,262

(22) PCT Filed: Jul. 7, 2004
(86) PCT No.: PCT/NZ04/00145

§ 371 Date: Feb. 5, 2007

(30) Foreign Application Priority Data
Jul. 7, 2003 (NZ) 526910

(51) Int. Cl. G06F 17/30

(52) U.S. Cl. 707/10

(57) ABSTRACT

A network system is provided that allows relationships between users of the system to be determined, maintained or created. The system may access connection data of users, for example by accessing a user's electronic address book, and from this determine which other users have a selected user as a contact.

### FIELD OF INVENTION

This invention relates to network systems and, particularly but not solely, to systems or methods of determining, creating or maintaining relationships between users of network systems.

### BACKGROUND

Technology offers a large number of network systems that users can use to effect various forms of communication. An obvious example is the network which is commonly referred to as the Internet. Other examples are the wireless telephone networks and wireless data networks.

As network systems and the tools that users' use to interface with such systems become more prevalent, for example, mobile telephones and mobile computing devices such as PDAs, they are increasingly becoming the means by which people maintain social contact.

Growth in the use of and reliance on network systems by individuals for communications and social contact means that, increasingly, individuals are almost continuously available to others in both their public and private lives. The increasing use of and reliance on such network systems has also engendered an expectation amongst users that other users of such network systems will be continuously contactable and a desire that communications between users be simple to establish and persistent in nature.

However, while the infrastructure underlying most network systems today may be very reliable, impediments remain. Limitations, for example, exist on how simply or quickly an individual can obtain another's network address (eg. Mobile phone number, email address etc), ascertain whether other individuals have a given individuals network address or keep a given individuals network address up to date.

A system or method of identifying, managing, maintaining and expanding the relationships between users of a network system provides the basis for addressing such impediments, enabling the rapid creation of new relationships and maintenance of existing relationships between users of a network system. Such a system or method would also provide a number of opportunities for the operators' of network systems since improving the quality and quantity of relationships/connections between users has significant possibilities for increased use of the network systems, or more efficient use, leading to increased operational revenues. Accordingly, there is a need for the determination, creation or maintenance of relationships between users of network systems.

### OBJECT

It is an object of the present invention to provide a system or method for determining, creating or maintaining relationships between users of a network system, or to provide a system or method which will at least provide the public with a useful alternative.

### SUMMARY OF THE INVENTION

In one aspect the invention may broadly be said to consist in a method for determining one or more relationships between a plurality of users of a network system, the method including the steps of:

populating a database with a unique user identifier for each of the plurality of users, further populating the database with connection data for each such user,
searching each user's connection data in the database for a predetermined user's unique user identifier to identify all users that have the predetermined user's unique user identifier in their connection data, and
storing the user identifiers located by the search (whether transiently or permanently) to provide an inbound connection set for the predetermined user representative of one or more other user's relationship with the predetermined user.

Typically the step of populating the database with connection data for each user will be accomplished by accessing the connection data stored on the users' network access devices. The connection data stored on a user's network access device (NAD) would also include connection data that while not physically stored on the NAD is still accessible to the user of the NAD or to applications present on the NAD, whether by some communications means, external storage or otherwise.

Preferably users may specify that certain user identifiers within their connection data not be accessible to other users of the network system or be included in any processing of data undertaken by the present invention. User identifiers so specified are “Blacklisted”.

Preferably a predetermined user may specify additional user identifiers that relate to the predetermined user to be associated with the predetermined user's unique user identifier. Such additional user identifiers may relate to the given network system or to any other network system. It is not necessary that the network system to which a given additional user identifier relates be interconnected with the given network system.

Preferably the record of a predetermined user's connection data in the database will be kept synchronised with the connection data stored in the predetermined user's NAD such that any changes to the connection data, whether originating on the NAD or on the database and whether initiated through interaction with the present invention or independently by the predetermined user, will be communicated from one to the other. Therefore, all processing of connection data undertaken by the present invention uses current and correct data.

Preferably, the step of searching the connection data stored in the database in respect of a predetermined user's unique user identifier may be performed for each user in the database. This may also include searching the connection data stored in the database for any additional user identifiers associated with the predetermined user.

Preferably, the step of searching the connection data stored in the database in respect of a predetermined user's unique user identifier or additional user identifiers may include searching the connection data stored in other databases connected to the first database. Searching of such other databases could either be carried out directly by communication between the first database and such other databases or could be carried out by communication between the first database and a centralised database and processing centre which replicates the data contained in the databases connected to it.

Preferably, the user identifiers comprised in the inbound connection set may be provided to the predetermined user.

Alternatively, the user identifiers comprised in the inbound connection set may be compared with the user identifiers comprised in the connection data for the predetermined user, and the user identifiers in the inbound connection set that do not comprise part of the connection data for the predetermined user be provided to the predetermined user.

Preferably, the user identifiers comprised in the inbound connection set may be compared with the user identifiers comprised in the connection data for the predetermined user, and some or all of the user identifiers in the inbound connection set that are not also present in the predetermined user's connection data may be selected by the predetermined user for automatic insertion into the connection data in the predetermined user's NAD.

Alternatively, the user identifiers comprised in the inbound connection set may be compared with the user identifiers comprised in the connection data for the predetermined user, and the user identifiers comprised in the connection data which do not also comprise part of the inbound connection set provided to the predetermined user.

Preferably, the user identifiers comprised in the connection data of the predetermined user may be compared with the user identifiers comprised in the inbound connection set, and the user identifiers comprised in the connection data which are not also present in the inbound connection set may be used to contact users whose user identifier appears in the connection data but not in the inbound connection set to invite them to include the predetermined user's user identifier in their connection data.

Preferably the predetermined user may choose which if any of the users identified in the preceding paragraph are invited to include the predetermined user's user identifier in their connection data.

Preferably users contacted in accordance with the preceding paragraph will have a NAD with an application present on it that will automatically intercept such communications and manage insertion of the predetermined user's user identifier into the connection data stored on the user's NAD, should the applicable user accept the predetermined user's invitation.

Preferably, the size of the inbound connection set may be used to provide an indication of the relative popularity of a user of the network system.

Preferably, the aggregate connection data of users of a given network system may be used to determine the popularity of users of an interconnected network system with the users of the given network system. Such a determination may be provided to the operator of the given network system or communicated to the users of the interconnected network system.

Preferably, if the user identifier for the predetermined user should change, the users comprised in the inbound connection set may be contacted, informing them of the change in the predetermined user's user identifier and providing them with the opportunity to update their record of the predetermined user's user identifier in their connection data.

Alternatively, if the user identifier for the predetermined user should change, instructions may be communicated to an application present on the NAD of each user comprised in the inbound connection set such that the record of the predetermined user's user identifier in the connection data on each NAD is updated automatically for each such user.

Preferably the predetermined user may choose which if any of the users identified in the preceding paragraphs are invited or otherwise contacted in relation to updating their record of the predetermined user's unique user identifier in the connection data stored on their NAD.

Preferably, if a predetermined user permanently leaves the network system for any reason then each user comprised in the inbound connection set may be contacted, informing them that the predetermined user's user identifier is no longer active and providing them with the opportunity to remove the predetermined user's user identifier from their connection data.

Alternatively, if a predetermined user permanently leaves the network system for any reason instructions may be sent to the NAD of each user comprised in the inbound connection set, such that the record of the predetermined user's user identifier in the connection data stored in the NAD is deleted for each such user.

Preferably the predetermined user may choose which if any of the users comprised in the inbound connection set are contacted in relation to the deletion of the applicable user identifier of the predetermined user from the connection data stored in their NAD.

Preferably a user may record user identifiers that they have used previously that are presently inactive or which have been reallocated to another user of the network system on a list of inactive user identifiers for that user.

Preferably, if the user identifier for a predetermined user should change then the old user identifier will be included on the list of inactive user identifiers for that user.

Preferably the step of populating the database for each user will determine if any of the user identifiers in the predetermined user's connection data are no longer active by reference to a list of known inactive user identifiers and provide the predetermined user with the opportunity to remove such inactive user identifiers from the connection data stored in the predetermined user's NAD.

Alternatively, the step of populating the database for each user will determine if any of the user identifiers in the predetermined user's connection data are no longer active by reference to a list of known inactive user identifiers and send instructions to an application on the predetermined user's NAD to remove the inactive user identifier's from the connection data stored in the predetermined user's NAD.

Alternatively, the step of populating the database for each user and determining if any of the user identifiers in the predetermined user's connection data are no longer active will also determine, in the event that an inactive user identifier is identified, whether an alternative active user identifier is available and if so provide the predetermined user with the opportunity to substitute the active user identifier for the inactive user identifier in the connection data stored on their NAD.

Typically users associate a name or identifier with each of the user identifiers that comprise the user's connection data.

Preferably users may associate a preferred name or identifier with their own user identifier.

Preferably the name or identifier associated with a predetermined user's user identifier in the connection data for each user comprised in the inbound connection set may be compared with the predetermined user's preferred name or identifier and any of the users comprised in the inbound connection set that do not use the predetermined user's preferred name or identifier in their connection data contacted to invite them to associate the predetermined user's preferred name or identifier with the predetermined user's user identifier in the connection data stored on their NAD.

Preferably the predetermined user may choose which if any of the users identified in the preceding paragraph are invited to use the predetermined user's preferred name or identifier in the connection data stored on their NAD.

Preferably users contacted in accordance with the two preceding paragraphs will have a NAD with an application present on it that will automatically intercept such invitations and assist, should the user wish to accept the predetermined user's invitation, in the process of changing the name or identifier associated with the predetermined user's user identifier in the user's connection data to be the name or identifier preferred by the predetermined user.

Preferably a predetermined user may request that the preferred name or identifier corresponding to a user identifier present in the predetermined user's connection data be provided to the predetermined user.

Preferably a predetermined user making a request in accordance with the preceding paragraph will have a NAD with an application present on it that will automatically intercept responses to such requests and assist in the process of changing the name or identifier associated with a user identifier in the predetermined user's connection data to the preferred name or identifier provided to the predetermined user.

Preferably, the record for each user in the database is further populated with one or more characteristics of each user. Characteristics may include the name and occupation of each user.

Preferably, the record for each user in the database may be searched for one or more such characteristics to determine which users possess the characteristic or characteristics.

Alternatively, the connection data of users in the database may be searched for a given user identifier to determine which users have a connection to the user associated with the given user identifier.

Preferably the record in the database for each user comprised in the predetermined user's connection data may be searched for at least one of the characteristics to determine which, if any, of the predetermined user's contacts possess the applicable characteristic.

Preferably the record in the database for each user comprised in the connection data of each user comprised in the predetermined user's connection data may be searched for at least one of the characteristics or for a given user identifier to determine if any of the contacts of the predetermined user's contacts possess the applicable characteristic or is the user associated with the given user identifier. This search may be extended deeper into the relationship hierarchy to users who have only a very remote relationship to those comprised in the predetermined user's connection data.

Preferably the results of any search for a given characteristic within a predetermined user's connection data or the results of any search for a given characteristic or a given user identifier within the connection data of each user comprised in the predetermined user's connection data pursuant to the foregoing paragraphs may be provided to the predetermined user.

Preferably the record in the database for each user comprised in the inbound connection set may be searched for at least one characteristic to determine if any of the users with a connection to the predetermined user possess the applicable characteristic.

Preferably the record in the database for each user comprised in the connection data of each user comprised in the inbound connection set may be searched for at least one characteristic or for a given user identifier to determine if any of the contacts of any of the users with a connection to the predetermined user possess the applicable characteristic or is the user associated with the given user identifier. This search may be extended deeper into the relationship hierarchy, for example to the connection data of users who have a very remote relationship with users in the inbound connection set.

Preferably the results of any search for a given characteristic within the inbound connection set or the results of any search for a given characteristic or a given user identifier with the connection data of each user comprised in the inbound connection set pursuant to the foregoing paragraphs may be provided to the predetermined user.

Preferably users of a network system may assign themselves or agree to be assigned to one or more groups. Such groups may represent clubs, families, workplaces or any other logical grouping of users. The user identifier and other characteristics of each member of the group will be associated with each such group.

Preferably each group member will be notified of the name and user identifier of each other member of the group. Such notification may be either automatic or upon the request of the group member. Such notification may occur either upon the formation of the group or at any subsequent time.

Alternatively, the name and user identifier of each member of the group will be delivered to the NAD of each member of the group such that each group member will be given the option of including each or all of the other group members name and user identifiers in the connection data stored on their NAD, either manually or via the assistance of an application resident on the group member's NAD.

Alternatively, the name and user identifier of each member of the group will be delivered to the NAD of each member of the group where such communications will be intercepted and processed by an application running on each user's NAD and the connection data stored on each group member's NAD automatically updated to include the name and user identifier of each of the other members of the group.

Preferably each member of the group will be notified of the name and user identifier of any member that joins or leaves the group.

Alternatively, the name and user identifier of any member that joins or leaves the group may be delivered to the NAD of each member of the group such that each group member will be given the option of adding or removing the name and user identifier of each such group member to/from the connection data, stored on the applicable group member's NAD either manually or via the assistance of an application resident on the group member's NAD.

Alternatively, the name and user identifier of each member that joins or leaves the group may be delivered to the NAD of each member of the group where an application on each NAD will intercept and process such communications such that the connection data stored on each group member's NAD is automatically updated to include/exclude the name and user identifier of each such joining/leaving group member.

Preferably each member of the group will be notified of any change in the user identifier of any member of the group.

Alternatively, the new user identifier of any group member may be delivered to the NAD of each group member such that each group member will be given the option to update the changed user identifier in the connection data stored on the group member's NAD, either manually or via the assistance of an application resident on the group member's NAD.

Alternatively the new user identifier of any group member may be delivered to the NAD of each group member where an application on each NAD will intercept and process such communications such that the connection data stored in each group member's NAD is automatically updated to include any changes to the user identifier of any other member of the group.

Preferably the present invention may be interconnected with alternative means of obtaining user identifiers and associated preferred names or identifiers (if any).

Preferably a predetermined user may request that a user identifier and associated preferred name or identifier (if any) provided to them by an alternative means be communicated to the predetermined user's NAD for incorporation in the connection data stored on the predetermined user's NAD.

Preferably the predetermined user's NAD will have an application on it that will automatically intercept such communications and assist in the insertion of any such alternative user identifiers and associated preferred names or identifiers (if any) provided to the predetermined user by an alternative means into the connection data stored on the predetermined users NAD.

Preferably a predetermined user may be provided with any additional user identifiers that may be associated with a given user's unique user identifier where such given user is comprised in the predetermined user's connection data.

Alternatively a predetermined user may be provided with any additional user identifiers that may be associated with a given user's unique user identifier for any given user.

Preferably one or more additional user identifiers provided to a predetermined user pursuant to the preceding paragraphs may be selected by the predetermined user for automatic insertion into the connection data in the predetermined user's NAD via the assistance of an application resident on the predetermined user's NAD.

In a further aspect the invention may broadly be said to consist in a system for determining relationships between users of a network system and determining the relationships by executing the method of any one or more of the preceding paragraphs.

In a further aspect the invention may broadly be said to consist in a computer system for determining relationships between users of a network system and determining the relationships by executing the method of any one or more of the preceding paragraphs.

In a further aspect the invention may broadly be said to consist in software for determining relationships between users of a network system and determining the relationships by executing the method of any one or more of the preceding paragraphs.

In a further aspect the invention may broadly be said to consist in storage media containing software as set forth in the preceding paragraph.

In a further aspect the invention may broadly be said to consist in apparatus for determining one or more relationships between a plurality of users of a network system, the apparatus including:

a database populated with a unique user identifier for each of the plurality of users and with connection data for each such user,
a processor adapted to search each user's connection data in the database for a predetermined user's unique user identifier to identify all users that have the predetermined user's unique user identifier in their connection data, and
a memory means to store (whether transiently or permanently) the user identifiers located by the search to provide an inbound connection set for the predetermined user representative of one or more other user's relationship with the predetermined user.

Typically the connection data for each user is provided to the database from the connection data stored on each such user's NAD. The connection data stored on a user's NAD would also include connection data that while not physically stored on the NAD is still accessible to the user of the NAD or to applications present on the NAD, whether by use of some communications means, external storage or otherwise.

Preferably the apparatus allows users to specify that certain user identifiers within their connection data not be accessible to other users of the network system or be included in any processing of data undertaken by the processor. User identifiers so specified are “Blacklisted”.

Preferably the apparatus allows a predetermined user to specify additional user identifiers that relate to the predetermined user to be associated with the predetermined user's unique user identifier. Such additional user identifiers may relate to the given network system or to any other network system. It is not necessary that the network system to which a given additional user identifier relates be interconnected with the given network system.

Preferably the record of a predetermined user's connection data in the database will be kept synchronised with the connection data stored in the predetermined user's NAD such that any changes to the connection data, whether originating on the NAD or from the database, and whether initiated through interaction with the present invention or independently by the predetermined user, will be communicated from one to the other. Therefore, all processing of connection data undertaken by the present invention uses current and correct data.

Preferably the processor is adapted to perform the step of searching the connection data stored in the database in respect of a predetermined user's unique user identifier for each user in the database and also includes searching the connection data stored in the database for any additional user identifiers associated with the predetermined user.

Preferably, the apparatus searches the connection data stored in other databases connected to the first database. Searching of such other databases could either be carried out directly by communication between the first database and such other databases or by communication between the first database and a centralised database and processing centre which replicates the data contained in the databases connected to it.

Preferably, the apparatus includes communication means to communicate the user identifiers comprised in the inbound connection set to the predetermined user.

Preferably, the processor may compare the user identifiers comprised in the inbound connection set with the user identifiers comprised in the connection data for the predetermined user, and the user identifiers in the inbound connection set which do not also comprise part of the connection data for the predetermined user be communicated to the predetermined user.

Preferably, the processor may compare the user identifiers comprised in the inbound connection set with the user identifiers comprised in the connection data for the predetermined user, and some or all of the user identifiers in the inbound connection set which do not also comprise part of the connection data for the predetermined user may be selected by the predetermined user for automatic insertion into the connection data stored in the predetermined user's NAD.

Preferably, the processor may compare the user identifiers comprised in the inbound connection set with the user identifiers comprised in the connection data for the predetermined user, and the user identifiers comprised in the connection data which do not comprise part of the inbound connection set be communicated to the predetermined user.

Alternatively, the processor may compare the user identifiers comprised in the inbound connection set with the user identifiers comprised in the connection data for the predetermined user, and the user identifiers in the connection data which do not comprise part of the inbound connection set be used by the communication means to contact users whose user identifier appears in the connection data but not in the inbound connection set to invite them to include the predetermined user's user identifier in their connection data.

Preferably the predetermined user may choose which if any of the users identified in the preceding paragraph are invited to include the predetermined user's user identifier in their connection data.

Preferably users contacted in accordance with the preceding two paragraphs will have a NAD with an application present on it that will automatically intercept such invitations and manage the insertion of the predetermined user's user identifier into the connection data stored on the user's NAD, should the applicable user accept the predetermined user's invitation.

Preferably, the processor may use the size of the inbound connection set to determine and the communications means to communicate a relative indication of a predetermined user's popularity in the network system to that user.

Preferably, the processor may use the aggregate connection data of users of a given network system to determine the popularity of users of an interconnected network system with users of the given network system. Such a determination may be provided to the operator of the given network system or communicated to the users of the interconnected network system.

Preferably, if the user identifier for a predetermined user should change, the processor may use the communications means to contact each user comprised in the inbound connection set, informing them of the change in the predetermined user's user identifier and providing them with the opportunity to update their record of the predetermined users user identifier in the connection data stored in their NAD.

Alternatively, if the user identifier for the predetermined user should change, the processor may use the communications to send instructions to an application present on the NAD of each user comprised in the inbound connection set such that the record of the predetermined user's user identifier in the connection data stored in the NAD is updated automatically for each such user.

Preferably the predetermined user may choose which if any of the users identified in the preceding paragraphs are invited or otherwise contacted in relation to updating their record of the predetermined user's user identifier in their connection data.

Preferably, if a predetermined user permanently leaves the network system for any reason the processor may use the communications to contact each user comprised in the inbound connection set, informing them that the predetermined user's user identifier is no longer active and providing them with the opportunity to remove the predetermined user's user identifier from the connection data stored on their NAD.

Alternatively, if a predetermined user permanently leaves the network system for any reason the processor may use the communications means to send instructions to an application present on the NAD of each user comprised in the inbound connection set, such that the record of the predetermined user's user identifier in the connection data stored on the NAD is deleted for each such user.

Preferably the predetermined user may chose which if any of the users comprised in the inbound connection set are contacted in relation to the deletion of the applicable user identifier of the predetermined user from the connection data stored in their NAD.

Preferably a user may record user identifiers that they have used previously that are presently inactive or which have been reallocated to another user of the network system on a list of inactive user identifiers for that user.

Preferably, if the user identifier for a predetermined user should change then the old user identifier should be included on the list of inactive user identifiers for that user.

Preferably during population of the database for each user the processor will determine if any of the user identifiers in the predetermined user's connection data are no longer active by reference to a list of known inactive user identifiers and communicate such inactive user identifiers to the predetermined user, providing the predetermined user with the opportunity to remove such inactive user identifiers from the connection data stored in the predetermined user's NAD.

Alternatively, during population of the database for each user the processor will determine if any of the user identifiers in the predetermined user's connection data are no longer active by reference to a list of known inactive user identifiers and send instructions to an application on the predetermined user's network NAD to remove the inactive user identifier's from the connection data stored in the predetermined user's NAD.

Alternatively, during population of the database for each user and determining if any of the user identifiers in the predetermined user's connection data are no longer active the processor will also determine, in the event that an inactive user identifier is identified, whether an alternative active user identifier is available and if so provide the predetermined user with the opportunity to substitute the active user identifier for the inactive user identifier in the connection data stored in their NAD.

Typically users associate a name or identifier with each of the user identifiers that comprise the user's connection data.

Preferably users may associate a preferred name or identifier with their own user identifier.

Preferably the processor may compare the name or identifier associated with a predetermined user's user identifier in the connection data for each user comprised in the inbound connection set with the predetermined user's preferred name or identifier and use the communications means and user identifiers specified in the inbound connection set to invite any of the users comprised in the inbound connection set that do not use the predetermined user's preferred name or identifier in their connection data to associate the predetermined user's preferred name or identifier with the predetermined user's unique user identifier or additional user identifiers in the connection data stored on their NAD.

Preferably the predetermined user may choose which if any of the users identified in the preceding paragraph are invited to use the predetermined user's preferred name or identifier in the connection data stored on their NAD.

Preferably users contacted in accordance with the two preceding paragraphs will have a NAD with an application present on it that will automatically intercept such invitations and assist, should the user wish to change the name or identifier associated with the predetermined user's user identifier in their connection data to the predetermined user's preferred name or identifier, in the process of changing the name or identifier associated with the predetermined user's user identifier in the user's connection data to be the name or identifier preferred by the predetermined user.

Preferably a predetermined user may request that the preferred name or identifier corresponding to a user identifier present in the predetermined user's connection data be communicated to the predetermined user.

Preferably a predetermined user making a request in accordance with the preceding paragraph will have a NAD with an application present on it that will automatically intercept such responses and assist in the process of changing the name or identifier associated with a user identifier in the predetermined user's connection data to the preferred name or identifier communicated to the predetermined user.

Preferably, the record of each user in the database is further populated with one or more characteristics of each user. Characteristics may include the name and occupation of each user.

Preferably, the processor may search the record for each user in the database for one or more such characteristics to determine which users possess the characteristic or characteristics.

Alternatively, the processor may search the connection data of users in the database for a given user identifier to determine which users have a connection to the user associated with the given user identifier.

Preferably the processor may search the record in the database for each user comprised in the predetermined user's connection data for at least one of the characteristics to determine which, if any, of the predetermined user's contacts possess the applicable characteristic.

Preferably the processor may search the record in the database for each user comprised in the connection data of each user comprised in the predetermined user's connection data for at least one of the characteristics or for a given user identifier to determine if any of the contacts of the predetermined user's contacts possess the applicable characteristic or is the user associated with the given user identifier. This search may be extended deeper into the relationship hierarchy to users who have only a very remote relationship to those comprised in the predetermined user's connection data.

Preferably the results of any search for a given characteristic within a predetermined user's connection data or the results of any search for a given characteristic or a given user identifier within the connection data of each user comprised in the predetermined user's connection data pursuant to the preceding paragraphs may be communicated to the predetermined user.

Preferably the processor may search the record in the database for each user comprised in the inbound connection set for at least one characteristic to determine if any of the users with a connection to the predetermined user possess the applicable characteristic.

Preferably the processor may search the record in the database for each user comprised in the connection data of each user comprised in the inbound connection set for at least one characteristic or for a given user identifier to determine if any of the contacts of any of the users with a connection to the predetermined user possess the applicable characteristic or is the user associated with the given user identifier. This search may be extended deeper into the relationship hierarchy, for example to the connection data of users who have a very remote relationship with users in the inbound connection set.

Preferably the results of any search for a given characteristic within the inbound connection set or the results of any search for a given characteristic or a given user identifier within the connection data of each user comprised in the inbound connection set pursuant to the preceding paragraphs may be communicated to the predetermined user.

Preferably users of a network system may assign themselves or agree to be assigned to one or more groups. Such groups may represent clubs, families, workplaces or any other logical grouping of users. The user identifier and other characteristics of each member of the group will be associated with each such group.

Preferably the processor may use the communications means to communicate the name and user identifier of each member of the group to the other members of the group. Such communication may be either automatic or upon the request of the group member. Such communication may occur either upon the formation of the group or at any subsequent time.

Alternatively, the name and user identifier of each member of the group will be communicated by the processor to the NAD of each member of the group such that each group member will be given the option of including each or all of the other group members name and user identifiers in the connection data stored on their NAD, either manually or via the assistance of an application resident on the group member's NAD.

Alternatively, the name and user identifier of each member of the group will be communicated by the processor to the NAD of each member of the group where such communications will be intercepted and processed by an application running on each user's NAD and the connection data stored on each group member's NAD automatically updated to include the name and user identifier of each of the other members of the group.

Preferably the processor will communicate the name and user identifier of any member that joins or leaves the group to the other members of the group.

Alternatively, the name and user identifier of any member that joins or leaves the group may be communicated by the processor to the NAD of each member of the group such that each group member will be given the option of adding or removing the name and user identifier of each such group member to/from the connection data stored on the applicable group member's NAD, either manually or via the assistance of an application resident on the group member's NAD.

Alternatively, the name and user identifier of each member that joins or leaves the group may be communicated by the processor to the NAD of each member of the group where an application on each NAD will intercept and process such communications such that the connection data stored on each group member's NAD is automatically updated to include/exclude the name and user identifier of each such joining/leaving group member.

Preferably the processor will communicate any change in the user identifier of any member of the group to the other members of the group.

Alternatively, the new user identifier of any group member may be communicated by the processor to the NAD of each group member such that each group member will be given the option to update the changed user identifier in the connection data stored on the group member's NAD, either manually or via the assistance of an application resident on the group member's NAD.

Alternatively the new user identifier of any group member may be communicated by the processor to the NAD of each group member where an application on each NAD will intercept and process such communications such that the connection data stored on each group member's NAD is automatically updated to include any changes to the user identifier of any other member of the group.

Preferably the present invention may be interconnected with alternative means of obtaining user identifiers and associated preferred names or identifiers (if any).

Preferably a predetermined user may request that a user identifier and associated preferred name or identifier (if any) provided to them by an alternative means be communicated to the predetermined user's NAD for incorporation in the connection data stored on the predetermined user's NAD.

Preferably the predetermined user's NAD will have an application on it that will automatically intercept such communications and insert any such alternative user identifiers and associated preferred names or identifiers (if any) provided to them by an alternative means into the connection data stored on the predetermined user's NAD.

Preferably any additional user identifiers that may be associated with a given user's unique user identifier may be communicated to a predetermined user where such given user is comprised in the predetermined user's connection data.

Alternatively any additional user identifiers that may be associated with any given user's unique user identifier may be communicated to a predetermined user.

Preferably one or more additional user identifiers communicated to a predetermined user pursuant to the preceding paragraphs may be selected by the predetermined user for automatic insertion into the connection data in the predetermined user's NAD via the assistance of an application resident on the predetermined user's NAD.

In a further aspect the invention may broadly be said to consist in a computer executable method for determining one or more relationships between a plurality of users of a network system, the method including the steps of:

populating a database with a unique user identifier for each of the plurality of users, further populating the database with connection data for each such user, searching the connection data present in the database for a predetermined user's unique user identifier to identify all users that have the predetermined user's unique user identifier in their connection data, and
storing (whether transiently or permanently) the user identifiers located by the search to provide an inbound connection set for the predetermined user representative of one or more other user's relationship with the predetermined user.

Preferably the user identifier information includes a user identifier and one or more characteristics of users such as name or occupation.

In a further aspect the invention may broadly be said to consist in a method for maintaining or creating one or more relationships between a plurality of users of a network system, the method including the steps of searching connection data to determine which users have a predetermined user's user identifier in their connection data, and informing the predetermined user of the users located by the search.

Preferably the predetermined user may also be provided with a subset of the users located in the preceding search, being those users located by the search whose user identifiers are not present in the predetermined user's connection data.

Preferably the set of users located by the search can also be used to provide the predetermined user with a further subset of users, being those users in the predetermined user's connection data that are not also included in the set of users located by the search.

In a further aspect the invention may broadly be said to consist in a method for maintaining or creating one or more relationships between a plurality of users of a network system, the method including the steps of providing a database populated with a unique user identifier for each of the plurality of users and with connection data for each such user, receiving any updated user identifier information and/or updated connection data, updating the database with the new information.

Preferably the method includes updating user's NADs with the new information.

Preferably the step of receiving the updated user identifier information and/or updated connection data includes receiving the information from a NAD.

Preferably the plurality of users may include a group of users, and updating information relating to a member of the group includes sending updated information to the other members of the group.

Preferably the method includes the step of inviting a user to establish a connection with a predetermined user or enabling a predetermined user to include another user's user identifier in the predetermined user's connection data.

In a further aspect the invention may broadly be said to consist in a method for maintaining or creating one or more relationships between a plurality of users of a network system, the method including the steps of: for a predetermined user, searching the connection data of all user's comprised in the predetermined user's connection data and the connection data of all user's that have the predetermined user's user identifier in their connection data for a selected characteristic to determine which users (if any) comprised in such connection data possess the applicable characteristic and storing user identifiers of users who have the selected characteristic.

Preferably the selected characteristic may include a connection to another predetermined user or a trade, profession, skill, interest or locality.

In a further aspect the invention may broadly be said to consist in a method of determining a user value indication for a user of a network system, the method comprising the steps of determining the connections for the user to determine a popularity indication for the user and providing the popularity indication to the user or to one or more other network systems as a value indication of the user to the network system.

In a further aspect the invention may broadly be said to consist in computerised apparatus programmed to implement a method of any one of the foregoing paragraphs.

In a further aspect the invention may broadly be said to consist in a back up system for a network system, the back up system including a central repository of data relating to a plurality of users of the network system, the repository including a unique identifier identifying each of the plurality of users and connection data for each of the plurality of users.

### DEFINITION

“Connection data” means a predetermined user's record of other users' user identifiers in a network system. Typically connection data will be stored on a predetermined user's NAD(s). By way of example the connection data may be obtained from, without limitation, one or more of: the address book of a mobile telephone (for example, resident on either a SIM card or in the phones own memory); a Microsoft Outlook™ Contact list; a Hotmail™ address book or the buddy/contact list of an instant messaging application such as ICQ, AOL Instant Messenger or MSN Messenger.

“Foreign network system” means a network system whose users use the services of an SDMS in another network system.

“Home network”, from the perspective of an SDMS, means the network system within which the SDMS resides.

“Inbound Connection Set” means a set of user identifiers (stored either transiently or permanently, for example stored in RAM or stored on a suitable magnetically or optically readable medium) comprising the user identifier of each user of a network system that has the user identifier of a predetermined user in their connection data.

“Network Access Device” or “NAD” means any device or other means used by users of a network system to access the network system.

“Network System” may include either a single network system or a plurality of interconnected network systems.

“SDMS” means subscriber data management system.

### DRAWING DESCRIPTION

A preferred embodiment of the invention will be described below by way of example with reference to the accompanying drawings in which:

FIG. 1 is a schematic of one or more network systems, illustrating how several networks may interconnect with each other and with the present invention;

FIG. 2 is a schematic of a part of the system of FIG. 1;

FIG. 3 is a series of tables illustrating possible examples of relationships between users of a network system; and

FIG. 4 is a diagram of a relationship determination process according to the invention.

FIG. 5 is a diagram of a user identifier update process according to the invention.

FIG. 6 is an illustration of one process of capturing user's connection data according to the invention.

FIG. 7 is a diagram of a name update process according to the invention.

FIG. 8 is a diagram of a preferred name notification process according to the invention.

FIG. 9 is a diagram of a skills search process according to the invention.

FIG. 10 is a diagram of an individual search process according to the invention.

FIG. 11A is a diagram of a group formation and operation process according to the invention.

FIG. 11B is a continuation of FIG. 11A.

### DESCRIPTION OF PREFERRED EMBODIMENT

A plurality of network systems comprising System A, System B, System C and any number of further additional systems, as represented by System X, are shown. Each of the network systems is based around a particular network, so System A includes a network A, System B includes a network B etcetera.

The present invention provides a subscriber data management system (SDMS). The SDMS is a repository for the storage of connection and other data held by users of a given network system or systems and the management and processing of such data.

SDMS functionality will be available to any network system with an SDMS and can also be extended to other network systems that are interconnected with the given network system, such as is shown by network interconnection 2, for example. Network interconnection typically enables the users of one network system to communicate with the users of another network system and accordingly can facilitate communication between the users of one network system and an SDMS located in another.

Network systems may also be connected at the SDMS level pursuant to the present invention by means of either a direct connection between SDMS (not shown) or an inter-operator exchange 3 or, for the purposes of back up and restore functionality, by means of an international gateway 6.

In each of the network systems, a number of users, such as Users A, B and C of System A, access the network A through a Network Access Device (NAD). The users may be individual persons or may be organisations of persons such as corporations for example. A user could also comprise a machine.

Typically the NAD will comprise an electronic machine. For example, if network A is a wireless telephone network such as a GSM network, then each NAD will typically comprise a wireless telecommunications device such as a mobile telephone. Should network A comprise a wired telecommunications network then the NADs may comprise a telephone connected to the wired network, network servers or personal computers for example. A NAD may comprise hardware, software or a combination of both. A personal computer 5 (a combination of both hardware and software) is shown as a NAD for accessing the Internet 4.

Each user will typically have a unique address or user identifier within the network system to which the user belongs. Continuing with the preceding example, if Network A is a wireless telephone network then each user's unique user identifier for that network would be a mobile phone number. The purpose of the unique user identifier is to enable other users within the network system (or of an interconnected network system) to make contact with the user.

Typically a user will have a record of other users unique user identifiers stored in their NAD. This record is the connection data for the applicable user, facilitating the establishment of connections with other users and freeing the predetermined user from having to remember a potentially large number of addresses.

Users must be able to communicate such connection data to the SDMS in order for it to be processed in accordance with the present invention. Typically connection data will be communicated by means of a transport mechanism and encoding protocol native to or at least understood by the network to which the user belongs and which the user's NAD is able to employ.

In the case of a mobile telecommunications network for example, a user may communicate their connection data by several different transport mechanisms, including by way of one or more SMS′, MMS′, a GPRS data connection, by way of a wireless connection technology such as an infrared, Bluetooth or Wifi connection or by a physical connection to the user's mobile telephone and/or SIM card (in the case of a GSM or other such network).

Prior to communication over the applicable transport mechanism the connection data can be encoded pursuant to either an open standard such as SyncML or a proprietary protocol (such as a protocol specifically developed to optimise communications of particular types/sizes of data over a given transport mechanism in a specific type of network), provided that such proprietary protocol is understood by both the NAD and the receiving server.

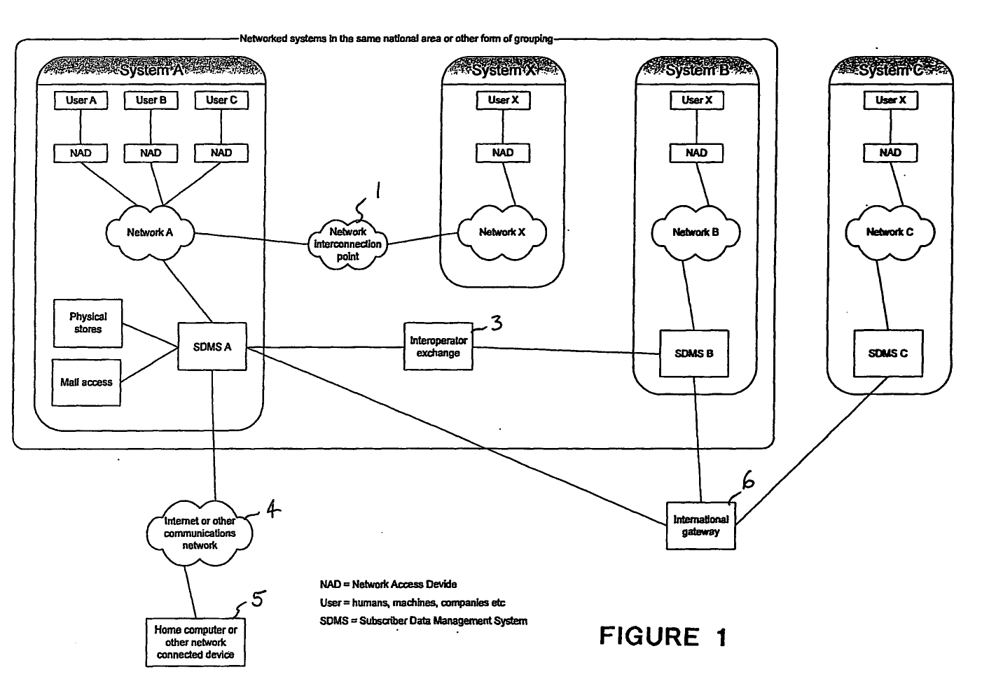

Provided there is means for communicating users' connection data to the SDMS (whether directly between the two network systems, via a third network system or some other means) it is possible that only one SDMS may be required or at least that several network systems may use a common SDMS. For example, System A and System X of FIG. 1 are connected by way of network interconnection 2 and accordingly may be served by the same SDMS, SDMS A, as connection data from users in System X can be conveyed to the SDMS in System A through the interconnection point.

Continuing with the example of the preceding paragraph, if System A and System X were both mobile telecommunications networks then the users of System X would be able to convey their connection data to the SDMS in System A by means of SMS, MMS GPRS or any other transport mechanism and protocol supported by the respective networks and the applicable users NADs. Expanding on this example, SDMS A would not be limited to only providing services to the users of its home network and those of System X (a “foreign network” from the perspective of SDMS A), it could also provide services to the users of other (preferably) interconnected network systems (not shown in FIG. 1).

Where the applicable network systems are not interconnected it is still possible for a single SDMS to provide services to the users of foreign network systems as the necessary communication between users and SDMS may take place by some alternative means. Such alternative means may include where the home network is connected to a third network system that is accessible to the users of the foreign network system. Another alternative, in the most limiting case, where no such other third network system exists, would be for the applicable users to interact directly with the SDMS through means made available by the operator of the home network. For example, in the case where the foreign network system is a mobile telecommunications network, the home network operator may make facilities available (for example in its stores) for the connection data to be downloaded directly from the mobile telephones of users of the foreign network system's mobile telephones.

Communication of connection data may be facilitated by the use of an application resident on user's NADs. Where the user is from a foreign network system this may require the consent or co-operation of the operator of the foreign network system. This application would then undertake some or all of the steps necessary to convey the user's connection data to the SDMS, and subsequent to initially populating the SDMS with the users connection data, continue to communicate with the SDMS to ensure that the connection data in the SDMS and NAD are kept synchronised.

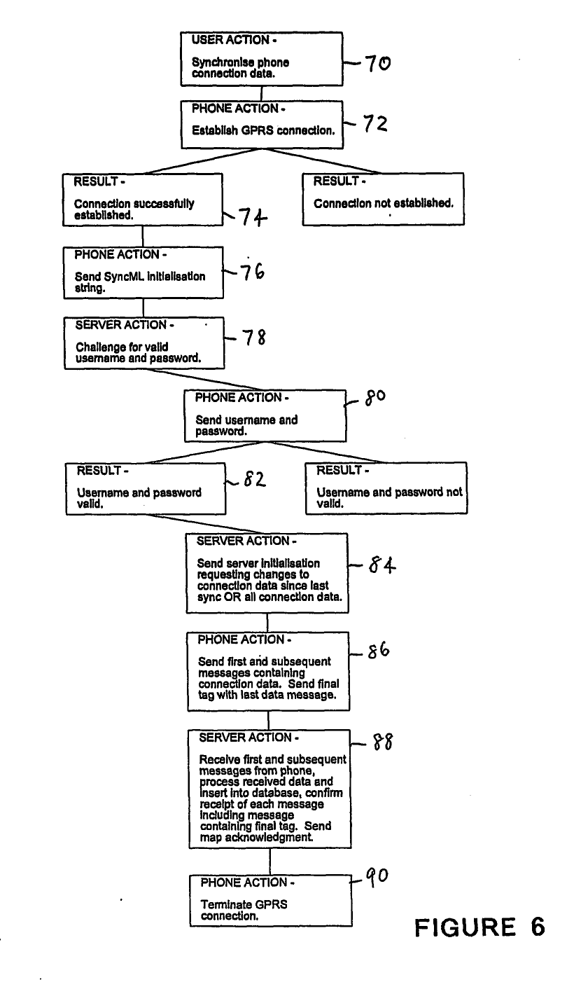

A simplified illustration of one means of populating of the database with connection data is provided in FIG. 6. In this illustration a mobile phone user wishes to communicate their connection data to the SDMS. The user's mobile phone supports the SyncML protocol so this protocol will be used to encode the connection data and GPRS will be used as the transport mechanism.

SyncML or Synchronisation Markup Language, is an industry-wide effort to create a single, common data synchronisation protocol optimised for wireless networks. SyncML's goal is to have networked data that support synchronisation with any mobile device, and mobile devices that support synchronisation with any networked data. The SyncML structured data layer uses XML wherever appropriate. SyncML is intended to work on transport protocols as diverse as HTTP, WSP (part of WAP) and OBEX, and with data formats ranging from personal data (e.g. vCard & vCalendar) to relational data and XML documents.

GPRS is the General Packet Radio Service that is part of the GSM standard and delivers “always-on” wireless packet data services to GSM customers. GPRS can provide packet data speeds of up to 115 kb/s. Using GPRS users of GSM mobile networks are able to send and receive information across the Internet, including sending and receiving information from applications such as the SDMS.

Referring to FIG. 6, the user initiates communication 70 in response to which their mobile phone establishes a GPRS connection 72, 74 and sends a SyncML initialisation string 76 to the SDMS.

The SyncML initialisation string sent by the phone provides the SDMS with detailed information regarding the mobile phone's SyncML capabilities. The SDMS processes the SyncML initialisation string and responds 78 requesting a valid username and password from the phone.

The phone sends the username and password (entered by the user when configuring their phone to use SyncML) to the SDMS 80 and, if valid 82, the SDMS responds with a server initialisation string 84 requesting either the changes to the connection data stored in the mobile phone since the last successful synchronisation between the mobile phone and the SDMS or alternatively, requesting all connection data stored in the mobile phone. The SDMS may request all connection data stored in the mobile phone for example when this is the first time that the mobile phone has attempted to synchronise with the SDMS or where there was an error during a previous attempt to synchronise with the SDMS.

The mobile phone complies with the server initialisation string and responds 86 by sending the first message containing connection data. The SyncML protocol uses messages to communicate connection data between clients and servers. During the process of establishing a SyncML session the client and server agree on such details as the maximum message size that they will use when communicating connection data between them.

The SDMS receives the message 88 from the mobile phone and processes the connection data inside it. Once the connection data has been processed and inserted into the applicable record in the database the SDMS responds affirmatively to the mobile phone which then proceeds to communicate its second message.

The mobile phone and SDMS will continue to communicate in this manner until the mobile phone reaches its last message, at the end of which it will include a final tag 88. When the SDMS encounters the final tag it will complete processing of the final message and then send messages (not shown) to the mobile phone with any connection data that may be required for the mobile phone and SDMS to remain synchronised.

The SDMS will include a final tag in its final message to the mobile phone at which point the mobile phone will provide the server with detailed information on the remote location where any connection data supplied to the mobile phone has been stored. Upon receipt of this mapping data the SDMS will process the remote location information and then send a map acknowledgement to the mobile phone.

Upon receipt of the map acknowledgment form the SDMS the mobile phone may terminate both the SyncML session and GPRS connection 90.

Other Systems B and C each have their own SDMS, being SDMS B and SDMS C respectively.

In the preferred embodiment of the invention, some or all of the individual SDMS′ may be linked by an international gateway 6, enabling connection data to be backed up and restored to user's NADs anywhere in the world by any network operator using the present invention and whose network is connected to the international gateway.

Each individual SDMS contains a record of the connection data of some or all the users within their home network (and possibly, at the operators discretion, a record of the connection data of some or all of the users of any interconnected network). An international gateway would be connected by a communications means to such of the individually operated SDMS′ as wished to use it. The communications means may comprise a dedicated link, secure VPN over the Internet or any other means of communication agreed between the operators of the applicable international gateway and SDMS. The operator of each such individual SDMS may use the communications means to communicate some or all of the connection data held by the SDMS to the international gateway(s) to which the SDMS is connected.

For as long as an SDMS is connected to an international gateway the operator of the SDMS may add to or remove connection data from the international gateway. Once a users connection data is included in an international gateway it will be kept synchronised with the copy stored in the applicable SDMS until it is removed from the international gateway by the operator of the applicable SDMS.

Where a user's connection data is stored in an international gateway they can, if required, such as where they have lost or damaged their original NAD, have their connection data restored to a NAD by the operator of any network with an SDMS connected to that international gateway.

By way of example, SDMS A, B and C of FIG. 1 are connected to an international gateway 6. User B of System A has their connection data stored in SDMS A and the operator of System A elects also to have User B's connection data stored in the international gateway 6. As User B modifies, adds to or deletes the user identifiers and associated names or identifiers comprised in its connection data such modifications, additions or deletions are communicated to SDMS A and correspondingly SDMS A instructs the international gateway 6 to update its record of User B's connection data. Subsequently, if User B is outside of System A and loses or damages their NAD, they can obtain another NAD and provided they are within a system connected to the international gateway 6, such as System C, they can request the operator of that system to access their connection data stored in the international gateway 6 and restore it to their new NAD.

For the purposes of the present invention there may be one, none or several international gateways. Without an international gateway (or an inter-operator exchange/direct link between two or more SDMS′ as noted below) direct restoration of connection data by the operator of network of which the user is not a subscriber will not be possible as the applicable operator will have no means by which to access the user's connection data in their home network. The absence of an international gateway (or an inter-operator exchange/direct link between two or more SDMS′ as noted below) however would not prevent, for example, a user operating in a network of which they are not a subscriber using a communications means supported by their NAD, the network that they are operating in and their home network from directly connecting with the SDMS in their home network and restoring their connection data. A mobile phone user may for example use their phone's GPRS connectivity to connect to the SDMS in their home network provided their phone, the network that they are operating in and their home network supported GPRS and its use to connect to the Internet.

The rules regarding intra-SDMS restoration of connection data will be prescribed by the operator of the applicable SDMS. The rules regarding inter-SDMS restoration of connection data will be prescribed by the operator of the applicable international gateway or inter-operator exchange, as the case may be, or in the case of two linked SDMS′, by agreement between the operators of the linked SDMS′.

Additionally, the operators of some SDMS′ may wish to interconnect their SDMS′ at a more fundamental level than that provided by an international gateway, either by means of an inter-operator exchange 3 that any operator may connect to, a private inter-operator exchange (not shown in FIG. 1) or by means of a direct link between SDMS′ (not shown in FIG. 1).

Linking individual SDMS′ or connecting them with an inter-operator exchange will enable connection data or results to be passed between such otherwise separate network systems.

In the case of a direct link between SDMS′, each SDMS processes requests from the users whose connection data is stored within the SDMS and, where applicable, also processes requests from users whose connection data is stored within the linked SDMS, such as for example, a request from a predetermined user requiring the inbound connection set in relation to that user. In the case of the foregoing example, the requesting user would be returned the user identifiers of all users in both networks that have the predetermined user's user identifier in their connection data. This ability for an SDMS to process connection data stored in other SDMS may be expected to significantly increase the usefulness of results provided to users over those that may otherwise be provided, especially where the respective SDMS′ operate in a similar geographic area such that there numerous connections between the users of the networks to which the respective SDMS′ relate.

Requests between directly linked SDMS′ could be transmitted over any communications means mutually acceptable to the operators of the linked SDMS′.

An inter-operator exchange 3 may operate in a manner similar to that specified above for a direct link between SDMS′, in which case the inter-operator exchange will perform the roll of a clearing house, receiving processing requests from each member SDMS, passing requests through to the other SDMS′, receiving results from each such SDMS, collating them and passing the results back to the originating SDMS. This manner of operation can be implemented using a hierarchy of CORBA (Common Object Request Broker Architecture) servers. The inter-operator exchange could receive a CORBA request for information and make subsequent CORBA requests to the constituent SDMS′ and then simply accumulate the results before returning them.

The operation of an inter-operator exchange may be illustrated by reference to FIG. 1. SDMS A and SDMS B are both connected to an inter-operator exchange 3. If User B requested SDMS A to provide it with a list of all users with a connection to User B then SDMS A will search the connection data of each user in SDMS A's database for User B's unique user identifier (and potentially any additional user identifiers that User B may have associated with its record in SDMS A's database). The result of this search will be User B's inbound connection set. In addition to searching the connection data stored in SDMS A's database, SDMS A will also communicate a request to SDMS B requiring that SDMS B search the connection data of each user in SDMS B's database for User B's unique user identifier (and potentially any additional user identifiers that User B may have associated with its record in SDMS A's database). SDMS B will return the result of this search to SDMS A, which will provide both sets of results to User B. Whether the results from each SDMS are merged, presented separately, given the same weight etc will be dependant on the configuration of the respective SDMS′ and the arrangement reached between the SDMS′ respective operators.

As the number of member SDMS′ in an inter-operator exchange grows beyond a small number however, the processing load that such a structure imposes on the individual member SDMS′ may grow uneconomically large. In which case, an alternative structure may be employed, whereby the inter-operator exchange itself would maintain a synchronised copy of the connection data held by each of the member SDMS′ and would itself process requests from connected SDMS′ against the data held by it. This manner of operation could be implemented by using database replication in which each constituent SDMS replicated it's data to the inter-operator exchange and the inter-operator exchange could directly process requests upon the superset of data.

The functionality of an inter-operator exchange is a superset of that of both a direct link between SDMS′ and an international gateway.

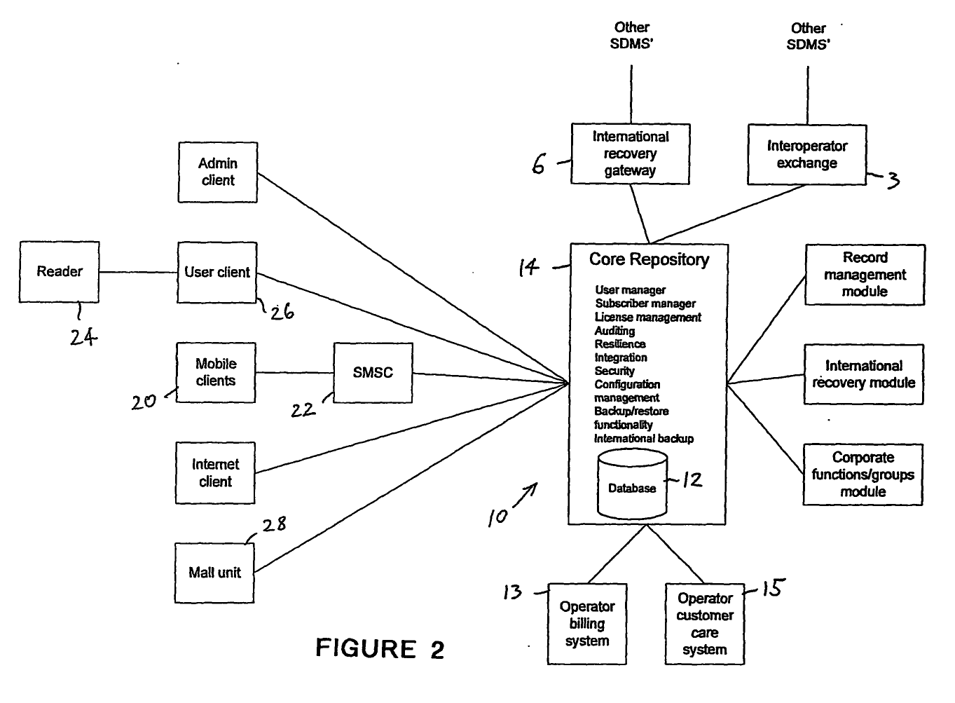

Turning now to FIG. 2, more information is provided about the functions of the SDMS according to the invention. The SDMS is generally referenced 10 in FIG. 2, and primarily consists of a computer system including a database 12 and system management software 14. The management software includes user management, licensing, auditing, resilience, integration, security, configuration and international recovery applications. Generally the management software ensures that users and subscribers of an SDMS are only permitted access to such data as is appropriate, to ensure that the SDMS is highly available, to manage the functionality available to the licensee of the SDMS, to manage the number of users/subscribers that may use the SDMS, to track activities undertaken within the SDMS etc. The database 12 may be a single database or distributed across several databases, which database(s) may be present on a single or several physical machines.

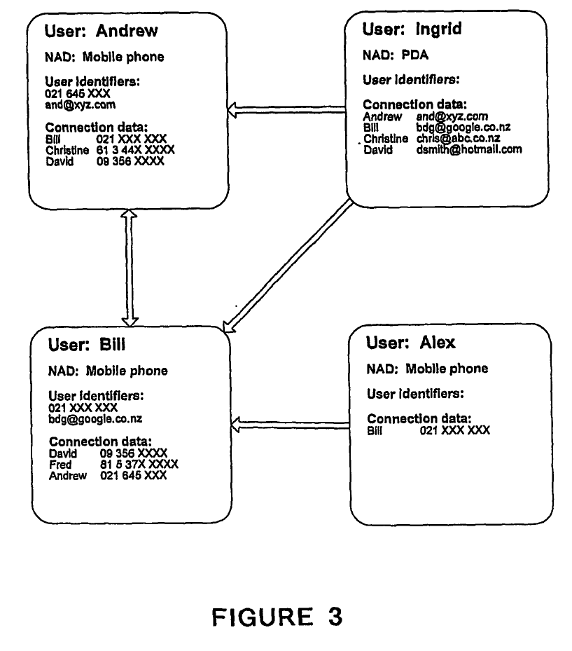

The data that is stored in the SDMS relates to relationships between users of the network systems that are served by the SDMS. The relationship data is most easily explained with reference to FIG. 3. Each user of the network will typically know one or more other users of the network i.e. will have a connection with one or more other users, and the NAD used by that user will typically store data relating to those connections along with one or more system addresses/user identifiers for those known users. One example of such connection data which may be stored in an NAD is the telephone number data that may either be stored on the SIM card of a mobile telephone or in the mobile telephone itself. Another example is the list of contact data that may be held in the “contacts” of a Microsoft Outlook™ user.

The connection data stored on NADs may be narrower in scope than that stored in the SDMS. The connection data stored in the SDMS may be supplemented by additional information to further facilitate the creation, determination and maintenance of relationships between users. For example, groups that users belong to (clubs, family groups, workplaces etc) may be recorded within the SDMS, along with information on users' locations, users' interests and professions etc. Multiple user identifiers for each user may also be stored.

Storing such supplemental data, such as the group data referred to in the preceding paragraph, enables the provision of additional services, such as enabling each member of the group to be kept current on the contact information of all other group members. In a further example, the storage of occupational data for some or all users would enable a predetermined user to search the connection data of users to which a predetermined user has a connection to see if any such users know anyone or any organisation of a particular type. Storing additional user identifiers for users also enables the determination, creation and maintenance of relationships between users not just across different networks but also across different types of networks.

Storing additional user identifiers also enables users that have a predetermined users user identifier to request the predetermined user's additional user identifiers. This would be of use, for example, where a user has the mobile number of a predetermined user but would actually like to send a fax to the predetermined user. In this case the user could select the known user identifier and request the system to send any other available user identifiers for the predetermined user to the user. If the predetermined user had included their fax number in their record within the SDMS then this number would be presented to the user enabling the user to send the predetermined user a fax. Such an example can similarly be applied to any network system such as an email system, public switched telephone network, postal network or otherwise.

User's that store additional user identifiers for themselves within the SDMS will have the opportunity to flag some or all of those additional user identifiers as not being available to requesters of additional user identifier information. A predetermined user may for example elect to make certain additional user identifiers available only to certain other users or class of users. This would allow, for example, a predetermined user to store their home telephone number within the SDMS so that they can utilise name and number invitations, number updates and other such features of the present invention that relate to users that may already have the predetermined user's home number without making that number available to any person that has one of the predetermined user's user identifiers.

The SDMS can communicate with network administration databases 13 and 15. For example, database 13 may comprise a billing database and database 15 may comprise a customer service database for a mobile telephone network. Therefore, changes to user details recorded on the customer service database may be immediately uploaded to the SDMS so that customer's records may be kept current. Similarly, services provided to network users by the SDMS can be billed to the network provider (in the case of users from a foreign network say), or to network users directly.

Turning to FIG. 3, a diagrammatic example of the data stored in SDMS 10 is illustrated. The names of four possible users, being Andrew, Bill, Ingrid and Alex, are set forth with the contact details of other users known to each of Andrew, Bill, Ingrid and Alex provided in tabular form beneath their names. Thus, for example, Andrew has a mobile telephone in which he has stored three contacts, being Bill, Christine and David. Bill has a mobile telephone in which he has stored details of three of his contacts. In this case each such contact's telephone number would be their unique user identifier. All of the contacts may belong to the same network system (eg: the same telephone network) or to other interconnected network systems (eg: different telephone networks).

Ingrid has an Internet email connection, provided on a personal digital assistant for example, and has stored details of the email addresses of Andrew, David, Christine and Bill.

This connection data, for each of these users, is provided to the SDMS 10. This may be achieved in a variety of ways. In the example of a mobile telephone the user has the option of transmitting the information wirelessly using the telephone. Therefore, the information may be transmitted from the mobile client 20 (FIG. 2) via a short message service centre 22 (or any communications medium supported by the particular NAD and network system) to the SDMS 10.

Alternatively, in the particular case of a GSM mobile network, the connection data may be downloaded from a SIM card using a SIM card reader 24 provided at a predetermined location such as a mobile phone retail outlet or similar centre 26. As another alternative, the connection data from the SIM card may be downloaded from a stand-alone booth or similar facility provided in a shopping centre, for example, such as a mail 28.

Ingrid's connection data is stored on her PDA and may be downloaded to the SDMS either wirelessly (if Ingrid's PDA supports a wireless communications means) or sent over a standard telephone network through a modem connection, for example. Alternatively, if Ingrid's connection data is stored on a server, such as a Hotmail server for example, then the information may be transferred directly from that server to the SDMS.

Before a user's connection data can be stored in the SDMS the user must be assigned a unique user identifier so that that particular user has a unique identity within the SDMS which can then be associated with their connection data and matched against entries in other user's connection data and with which other data for the predetermined user can be associated (for example, alternative contact addresses, profession etc).

In most cases it is likely, but not required, that the unique user identifier for a particular user will simply be their contact address in the network system within which the SDMS is located. Where users of a network system have several contact addresses within the home network or contact addresses in foreign networks that are interconnected with the home network then it is also likely, but not required, that one of the contact addresses from within the home network will be chosen as the unique user identifier.

Alternatively the operator of the SDMS may elect to generate unique user identifiers that are unique to the SDMS itself. If the operator of an SDMS elects to create SDMS specific unique user identifiers for each user then such unique user identifiers will not be used to determine relationships and other processing undertaken pursuant to the present invention as such unique user identifiers will exist in the particular SDMS only and accordingly not be present in any user's connection data. In such circumstances users must enter at least one additional user identifier and such additional user identifiers shall be used to determine the relationships between users and other such processing undertaken pursuant to the present invention.

Any contact address for a given user that is not used as a unique user identifier for that user will be associated with that user's unique user identifier. Such additional user identifiers associated with a user's unique user identifier may automatically be included in requests processed by the SDMS or alternatively the SDMS may be configured such that only a user's unique user identifier is used when processing requests or that a user is given the option of including such additional user identifiers in processing undertaken by the SDMS.

Once the SDMS has been populated with a user's connection data the record of that data in the SDMS and NAD are kept synchronised. Typically synchronisation is maintained by an application present on the NAD (which application may either be incorporated within the operating system of the NAD or comprise a separate application loaded onto the device by the user or operator of the network) communicating any changes to the connection data stored on the NAD to the SDMS, and the SDMS communicating any changes to the connection data stored in the SDMS to the NAD.

Other schemes for maintaining synchronisation exist and may be used. For example, in the case where the NAD is not capable of running an application or which does not natively support a protocol for the exchange of connection data such as SyncML, full synchronisation will be intermittent, with the user of the NAD receiving notification from the SDMS of changes to the connection data stored in the SDMS and the user then manually entering such changes into the connection data stored in the NAD. Additionally, in this limited case any changes to the connection data on the NAD will not be synchronised with the connection data in the SDMS until the user directly connects the NAD to the SDMS or to a system designed to directly connect the NAD to the SDMS. Relatively infrequent synchronisation of the SDMS and NAD versions of the connection data is however suboptimal as not only will it put the connection data on the NAD at risk of being lost but it would also result in numerous aspects of the present invention returning less accurate results because of out of date data and potentially require significantly more human involvement when synchronisation does occur to resolve conflicts between the SDMS and NAD versions of the connection data.

If Bill and Andrew of FIG. 3 belong to the same network system (in this instance, a mobile telephone network), their connection data will be stored in the same SDMS. If Bill and Andrew belong to different network systems (eg: different mobile networks) then several alternate configurations are possible, their connection data may for example be stored in two separate unlinked SDMS′, in two separate but linked SDMS′ or the operator of one network may operate an SDMS and permit users from the other operator to store connection data in the first operator's SDMS. Where SDMS′ are linked they may be considered as a single SDMS for the purposes of the functioning of the present invention. For the purposes of the present example we assume that Andrew and Bill belong to the same network and that their connection data is stored in the same SDMS.

Ingrid's connection data may also be stored in the same SDMS as Bill and Andrew, but it may also be stored in a separate SDMS within the network system to which she belongs (an email network). If Ingrid's connection data is stored in a separate SDMS (and potentially even if they are stored in the same SDMS, depending on how records in the applicable database are indexed and cross-referenced) that is linked to the SDMS storing Bill and Andrews connection data then Bill and Andrew will also need to have associated their respective user identifiers in the network to which Ingrid belongs with their unique user identifiers in their home SDMS in order for the entries relating to them in Ingrid's connection data to be correctly matched with the actual record of Bill and Andrew in the SDMS.

Referring to FIG. 3 it can be seen that both Andrew and Bill have associated an additional user identifier, namely their respective email addresses, with their unique user identifiers (their respective mobile phone numbers) and accordingly the user identifiers for Andrew and Bill in Ingrid's connection data will be correctly matched with the record for Andrew and Bill stored in their SDMS.

Typically when user's connection data is first entered into the SDMS the SDMS will search the connection data for any user identifiers that are no longer active within the network system or any interlinked network systems. User's will be given the opportunity to manually remove, or where the necessary information is available update, any such inactive user identifiers in their connection data or where the user's NAD is running an application then the application may automatically delete or update any such inactive user identifiers that the user agrees should be removed or updated.

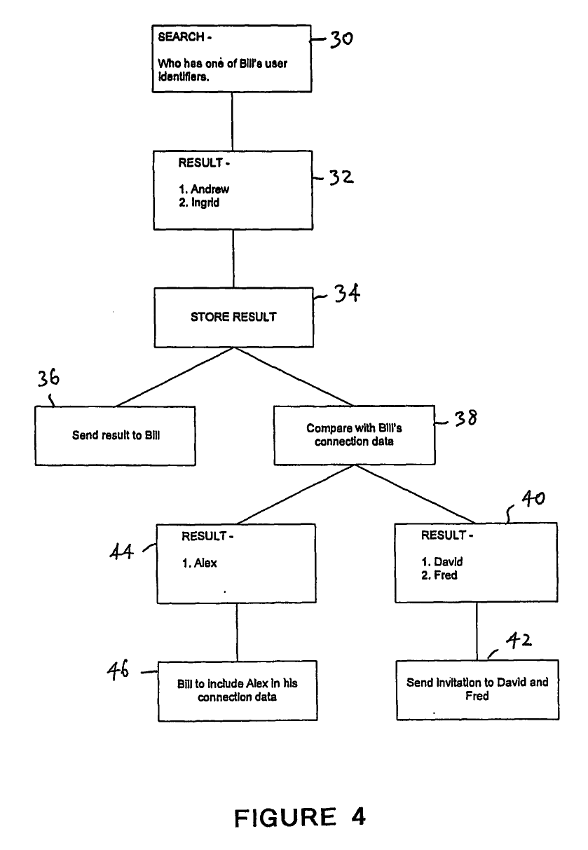

Having obtained the raw relationship data, the present invention allows the data to be used to determine the relationships between users. One application of the invention is shown in FIG. 4. In this case, Bill may wish to determine who in the SDMS has one or more of his contact addresses in their connection data.

The first step is to perform a search for one or more of a predetermined user's user identifiers in the connection data of the other users in the SDMS. In the case of the connection data provided in the example of FIG. 3, the method involves performing a search for a predetermined user to see who has that user's user identifier(s) in their connection data. Therefore, in step 30 of FIG. 4, a search of the data in the database 12 is performed to see who has Bill's user identifier(s).

In the case where Andrew and Bill are in the same SDMS (or in interlinked SDMS′) and the search is for people that know Bill's telephone number (Bill's unique user identifier within the telephone network) then the result returned will be “Andrew” (for simplicity of the present example only we will ignore the user Alex). Alternatively, if the search is for Bill's email address (Bill's user identifier within an email network) and we assume that Andrew, Bill and Ingrid are all in the same SDMS (or in interlinked SDMS′) then the result returned will be “Ingrid”. Alternatively, if the search was for either of Bill's contact addresses (in this instance, telephone number and email address) and we assume that Andrew, Bill and Ingrid are all in the same SDMS (or in interlinked SDMS′) then the result returned will be both “Andrew” and “Ingrid” and a means of distinguishing which contact address each held.

The result shown in step 32 is that Andrew and Ingrid both have Bill as a contact. In step 34 the result is stored as Bill's inbound connection set. At this point it can be seen that these steps may be repeated for each user of the network system in the database. It is desirable but not essential that the steps be repeated for each user as doing so will enable the database to be appropriately indexed, or a separate database maintained within which the relationships between users is clearly set forth, i.e. there is a record for Andrew which indicates each of Andrew's contacts and there is also a list of those who have Andrew as a contact.

Continuing with FIG. 4, the information in relation to those who have Bill as a contact may be provided to Bill, for example by being sent by SMS message to Bill's mobile telephone, in step 36 for his information.

When user's connection data is first entered into the SDMS they are able to “Black list” particular user identifiers present in their connection data. User identifiers that have been “Black listed” are not accessible to other users of the system or included in certain processing undertaken by the SDMS. Referring to the preceding example, if Andrew had “Black listed” Bill's user identifier in his connection data when it was entered into the SDMS then the result shown in step 32 would be that only Ingrid has Bill as a contact, the fact that Andrew also has Bill's user identifier in his connection data would be ignored by the SDMS. The behaviour of the SDMS specified above in respect of “Black listed” user identifiers applies in respect of all other SDMS services involving user interaction, including for example, the generation of name and number updates, number invitations, dead link removal etc.

Users may also “Black list” user identifiers in their connection data at any time after their connection data is first entered into the SDMS.

Using a further application of the present invention Bill can then use this information to ask those individuals in his connection data who do not themselves have his user identifier in their own connection data whether they would like to receive it. This process is preferably performed as part of the operation of the SDMS and is shown in step 38 where a comparison is performed between the user identifiers in Bill's connection data and the inbound connection set from step 34. The result is set forth in step 40 which shows that “David” and “Fred” either do not have Bill's number in their connection data or that their connection data is not stored in the SDMS.

The step of displaying the result to Bill would also include distinguishing between user's who definitely do not have Bill's user identifier (known because their connection data is stored in the SDMS) from those users that may not (whether they do or not is not known definitively as their connection data is not stored in the SDMS).

The next step 42 is to enable Bill to issue invitations to “David” and “Fred” asking them if they would like to receive Bill's number for inclusion in the connection data. Such invitations would be issued by any means of communication supported by the recipients of the invitation. In a mobile telecommunications network for example such invitations may be issued by way of an SMS message. Where an invitee is connected to an SDMS then they may have an application operating on their NAD that intercepts such invitations, presents the invitation on the NAD's graphical display and automatically inserts Bill's user identifier into their connection data for them should they wish to accept it. Where invitee's are not connected to an SDMS then the invitation may simply be displayed on the screen of the invitee's NAD in which case the invitee would be required to manually enter Bill's user identifier into the connection data on their NAD or the invitation may be sent to their NAD in a format understood by their NAD as containing contact data, such as the popular vCard format, enabling them to simply direct their NAD to accept the received contact details. In the case where the invitee is a machine then whether or not such invitations are accepted would depend on the rules for acceptance programmed into the invitee.

Using a further application of the present invention Bill is also able to determine if there are any users that have his user identifier in their connection data but for which he does not have their corresponding user identifier in his own connection data. This process is preferably performed as part of the operation of the SDMS and may also be shown in step 38 where a comparison is performed between the user identifiers in Bill's connection data and the inbound connection set from step 34. The result is set forth in step 44 showing that Alex is a person who has Bill's number but Bill does not have his. The next step 46 is to provide Bill with the opportunity to store Alex's user identifier, provided Bill's NAD was configured to receive that form of user identifier.

The SDMS may also provide a list to a predetermined user of those other users who have the predetermined user's user identifier(s) (ie: the predetermined user's inbound connection set) on demand. Also, as described above, the system may be configured to automatically send invitations to users who do not have the user identifier of another user who has the invitee's user identifier in their connection data.

Using a further application of the present invention, knowing the relationships between users, the system can also provide further useful functionality by providing a user identifier update service.

Referring again to FIG. 3, if Andrew's user identifier in the network system should change, Andrew can request that the SDMS advise any other users that have the applicable user identifier in their connection data of this fact. Alternatively the SDMS may be configured to automatically advise others with the applicable user identifier of any changes or to advise anyone with any of Andrew's user identifiers of any change to any of them.

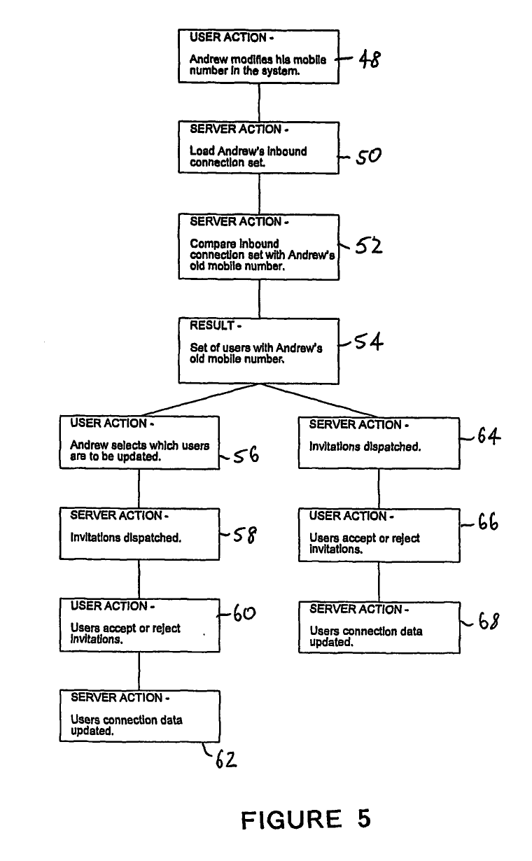

The process for providing a user identifier update service may be illustrated by reference to FIG. 5. Using the example outlined above, Andrew, one of the users specified in FIG. 3, changes his mobile number and in the simplest case, updates it in his record in the SDMS 48. It will be obvious that where the user identifier being modified relates to the home network then the applicable network operator's own systems may be sufficiently integrated with the SDMS to enable those systems to automatically modify the record for the predetermined user in the SDMS, making this step redundant in such cases.

The change in Andrew's user identifier is registered by the SDMS which then load's his inbound connection set 50 and searches 52 for Andrew's old number in the connection data of each user comprised in the inbound connection set to determine the set of users that may need to be updated 54. The inbound connection set comprises all users (from any network system that either uses the services of the SDMS in Andrew's network or which has its own SDMS which is connected to the SDMS in Andrew's network) that have any of Andrew's user identifiers in their connection data. If the inbound connection set in a given SDMS is dynamically generated rather than stored then the step of loading the inbound connection set 50 will not be applicable and the step of searching the inbound connection set 52 for Andrews old number will instead refer to searching the records of all users in the SDMS for Andrews's old number. The use of indexing and other modern database technologies means that preloading and searching the inbound connection set will not necessarily be more efficient than simply searching the entire database for all users with the applicable user identifier in their connection data.

The result 54 may either be used by the SDMS to automatically issue invitations 64 to users with the predetermined users old number in their connection data, notifying them of the predetermined users new number, or alternatively, the result may be provided directly to the predetermined user to enable them to determine 56 which users with their old number will be invited 58 to update their record of the predetermined users old number in the connection data stored on their NAD.

In the present example, if the system was configured to automatically issue invitations 64, Bill would receive a message advising him that Andrew's mobile number had changed and prompting him to accept the new number provided with the message 66.

Users receiving an invitation to update their record of the predetermined users old number in the connection data stored on their NAD may elect 60, 66 whether or not to accept the invitation and if accepted, their record of the applicable user identifier for the predetermined user will be updated to the new user identifier entered into the system by the predetermined user 62, 68.

Preferably users receiving an invitation to update their record of a predetermined users old number in the connection data stored on their NAD will have an application operating on their NAD that intercepts such invitations, presents the invitation on the NAD's graphical display and automatically updates the applicable user identifier for the predetermined user in their connection data for them should they wish to accept it.

A further function provided by the system allows users to specify a preferred name or identifier to be associated with their user identifiers in other user's connection data. In FIG. 3 for example Bill may wish that other users of the network system associate the name “Bill Smith” with his user identifiers. Having specified his preferred name Bill could then request the system to compare his preferred name to the name or identifier associated with his user identifiers in other user's connection data and issue name invitations to those users that do not currently use “Bill Smith” in association with Bill's user identifier. This functionality will have particular application to situations where a user changes their name, such as where a woman may change her name after getting married or where a company name is changed after a buy-out or merger. This functionality may also be useful where a user would prefer to be known by a particular nickname.

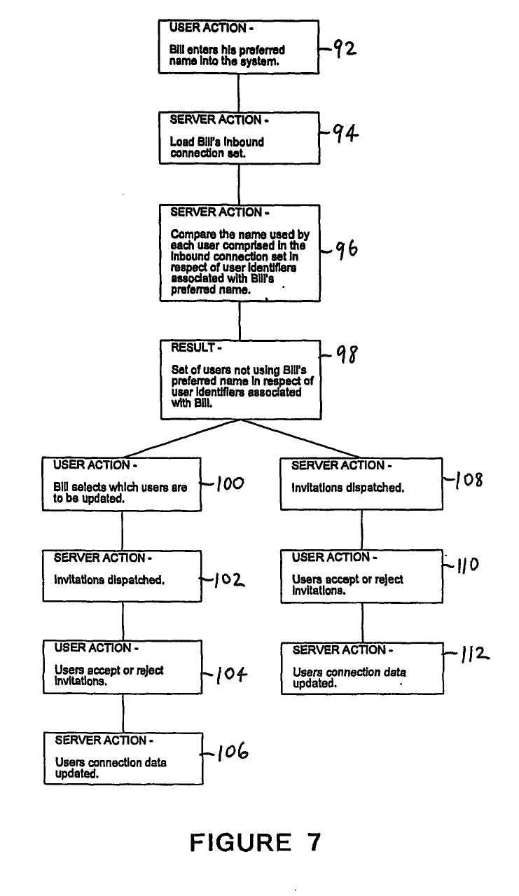

The process for providing a user identifier update service may be illustrated by reference to FIG. 7. Using the example outlined above, Bill, one of the users specified in FIG. 3, wishes other users of the system to use “Bill Smith” in relation to user identifiers associated with him and specifies this 92 as his preferred name in the SDMS.

Whenever a user enters or modifies their preferred name the SDMS will provide them with the opportunity to invite other users to use this name. In the present case, should Bill wish to do this the SDMS will load Bill's inbound connection set 94 and compare 96 the name or identifier used in the connection data of each user comprised in the inbound connection set to determine a set of users 98 that are not currently using Bill's preferred name in relation to user identifiers associated with Bill.

The system may be configured to enable a predetermined user to choose which, if any, of the user's not currently using the predetermined user's preferred name actually receive a name invitation or alternatively the system may be configured to issue a name invitation to all users that are not using the predetermined user's preferred name.

In the present example neither Alex or Andrew are using Bill's preferred name and so name invitations will either be sent automatically to these users 108 asking if they would like to change the name associated with Bill's user identifier in their connection data from “Bill” to “Bill Smith” or where the system is configured to provide Bill with the set of user's not currently using his preferred name then Bill will have the opportunity 100 to elect that one, both or neither of Alex and Andrew receive name invitations.

Upon receiving a name invitation Alex and/or Andrew could either ignore the invitation, manually update the connection data stored in their respective NADs or in the case where one or both of them have an application present on their NAD, agree to the change and have the application automatically modify the name associated with Bill's user identifier in the connection data stored in their NAD.

Additionally, having user's preferred names or identifiers stored in the SDMS allows users with one or more of a predetermined user's user identifiers to request the predetermined user's preferred name. This would be of use for example where a user only has part of the predetermined users name or where the predetermined users name is difficult to spell.

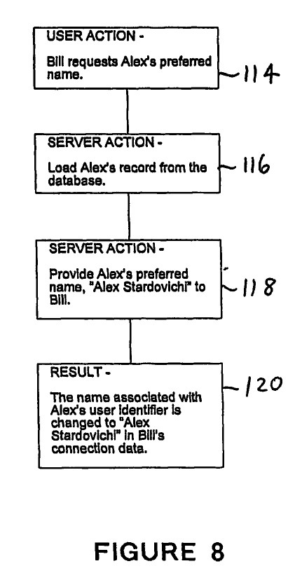

The process for providing a preferred name notification may be illustrated by reference to FIG. 8.

Bill has recently been provided with Alex's mobile phone number and wishes to include it in his mobile phone's address book. Although Bill is able to recall Alex's first name he cannot recall the correct spelling of his last name, “Stardovichi”.

Bill enters Alex's mobile number and name into his phone and synchronises it with the record of his connection data stored in the SDMS. Bill then requests Alex's preferred name 114.

The SDMS loads Alex's record from the database 116 and if it includes a preferred name provides this to Bill 118. Bill can now update the name associated with Alex's mobile number in his phone 120, which change will in due course be reflected in the record of his connection data stored in the SDMS the next time he synchronises his phone with the SDMS. Alternatively the SDMS may be configured to accept an instruction to modify the name associated with Alex's mobile number in the record of Bill's connection data stored in the SDMS, in which case the name associated with Alex's mobile number in Bill's mobile phone will also be updated to be Alex's preferred name the next time Bill synchronises his mobile phone with the SDMS.

Preferably users receiving an preferred name notification in respect of a predetermined user will have an application operating on their NAD such that if the user directs that their connection data be updated to use a preferred name for the predetermined user then the SDMS is able to both appropriately update the record of the users connection data stored in the SDMS and send an instruction to the user's NAD instructing the application on the user's NAD to also update the name associated with the predetermined user in the connection data stored on the user's NAD.

The system also allows contact detail recovery. For example, should a mobile telephone user lose his or her telephone, a replacement phone may be obtained and the connection data downloaded to the user's phone and/or SIM card, i.e. the user's old telephone address book could be obtained from the SDMS. User's connection data will be available to users for recovery purposes from the operator of the network system to which they belong and also from the operator of any network system that has an SDMS according to the present invention, provided any such SDMS is connected to the SDMS to which the user belongs, whether by direct link between the SDMS′, by connection to an inter-operator exchange or by connection to an international gateway.

By way of example, should a user belong to a GSM mobile telephone network in Australia and the user loses their phone in the United Kingdom, then the user could purchase a new mobile phone from a GSM mobile operator in the United Kingdom and, provided the UK GSM mobile operator operated an SDMS according to the present invention which is connected to the SDMS of the network system to which the user belongs in Australia, then the UK GSM mobile operator can access the users connection data and restore it to a new SIM card or mobile phone for the user.

Another function provided by the system is the provision of a popularity indication to those who are interested. Using the data stored in the SDMS, a search may be implemented to see how many other users have any particular user's user identifier(s). Also, an overall ranking may be achieved amongst all the users of the system so that a user can determine how popular he or she is. This information will be of particular interest to certain demographics within a network operator's customer base, such as teenage subscribers. Such information will also be of interest to network operators themselves as presumably popular individuals are more influential than less popular individuals and so may be more particularly targeted for marketing purposes. Further, it is likely that if being popular is perceived as desirable then individuals will seek to make their user identifiers more widely known which in turn is likely to increase the frequency of contact between individuals which in networks that charge on the basis of usage is likely to result in additional revenue to the network operator.

An additional function provided by the SDMS is the ability for the operator of a given network system to determine the popularity of users of other network systems interconnected with the given network system with the users of the given network system. It is often the case that the operator of a given network system will have to pay the operators of interconnected network systems for communications between users of each network system where such communication is initiated by a user of the given network system (eg: in the case of a mobile telecommunications network, a call from the user of one mobile telephone network to a user of a different mobile telephone network). It may be assumed that if a user of another network is popular with the users of a given network then users of the given network will call the popular user more frequently than would otherwise be the case. In this case the operator of the given network system may be paying considerable interconnection charges to the operator of the other network, which charges could be avoided if such popular users could be identified and induced to change to the given network system.

A further service relates to common contacts amongst users. The database 12 may be searched to determine those users who have a common user identifier in their connection data. For example, with reference to FIG. 3, both Bill and Ingrid have Andrew and David as common contacts.

More usefully perhaps, the connection data also allows indirect user relationships to be determined. For example, referring again to FIG. 3 we see that Ingrid has contact addresses for Andrew and Bill in her connection data. We can look to Andrew and Bill's connection data and see that Ingrid has indirect connections to Andrew and Bill's contacts i.e. to Christine and Fred. Further indirect connections may also be established.

The capability to determine indirect user relationships provides particular advantages in terms of locating people with particular skills or attributes. People always require the services or skills of others from time to time but there is often difficulty in finding an appropriate person, particularly when the service is one which has not been required in the past, or is one that a user has been previously unhappy with. Therefore many people try to seek a recommendation or at least a suggestion from other people before employing the services of a particular individual. For example, in the case of a plumber, a user may not have required the services of a plumber previously and may not know anyone in his or her immediate circle of contacts who is qualified as a plumber. Therefore, an individual who requires the services of a plumber may wish to make enquiries of friends or other acquaintances to see if any of them are able to suggest an appropriately qualified person.

With the present system, the record for each user includes, where possible, other information such as their occupation. Therefore, the present invention allows the problem set out above to be solved. This can be done by searching the connection data of all the users known to a predetermined user (being the users comprised in the predetermined user's connection data) or that know the predetermined user (being the users comprised in the inbound connection set for the predetermined user) to determine whether any such users themselves know an appropriately qualified person.

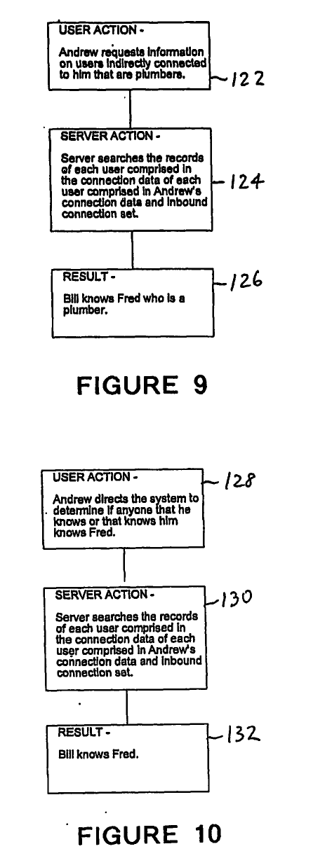

The process for determining if any indirect contacts possess certain skills may be illustrated by reference to FIG. 9.

If, by way of example, Andrew is seeking the services of a plumber and Andrew knows that Bill, Christine and David are not appropriately qualified, then Andrew may ask the SDMS to determine if any of the people he knows (ie: Bill, Christine and David in the present example) or which know him (ie: Ingrid) knows a plumber 122. The SDMS would then search the connection data of each of the user's comprised in Andrew's connection data and inbound connection set (to the extent that such connection data is stored within the system) to see if any of them know an appropriately qualified person 124. If they do, then the SDMS can provide Andrew with the appropriate contact details 126, so that Andrew can contact those people. In the case of Andrew and his requirement for a plumber, it may be that Fred is a plumber and that he has included this fact in his record in the database 12, in which case the system will return a successful result indicating that Fred is a plumber and that Fred is a contact of Bill's. In this way Andrew can contact Bill and ask Bill about Fred's services as a plumber and if Bill feels that Fred is likely to be an appropriate person, Bill can recommend Fred to Andrew.

In a further application of the present system, indirect connections can be sought not only for individuals with particular skills (as described above) but also for particular individuals themselves. Referring again to FIG. 3, it may be that Andrew has determined that he would like to contact Fred for business purposes. While Andrew may contact Fred directly, Andrew may first want to find out a little more about Fred's reputation in the business community and also look for an introduction from a mutual contact that would increase the likelihood of Andrew's approach being well received by Fred. The present invention enables this problem to be solved.

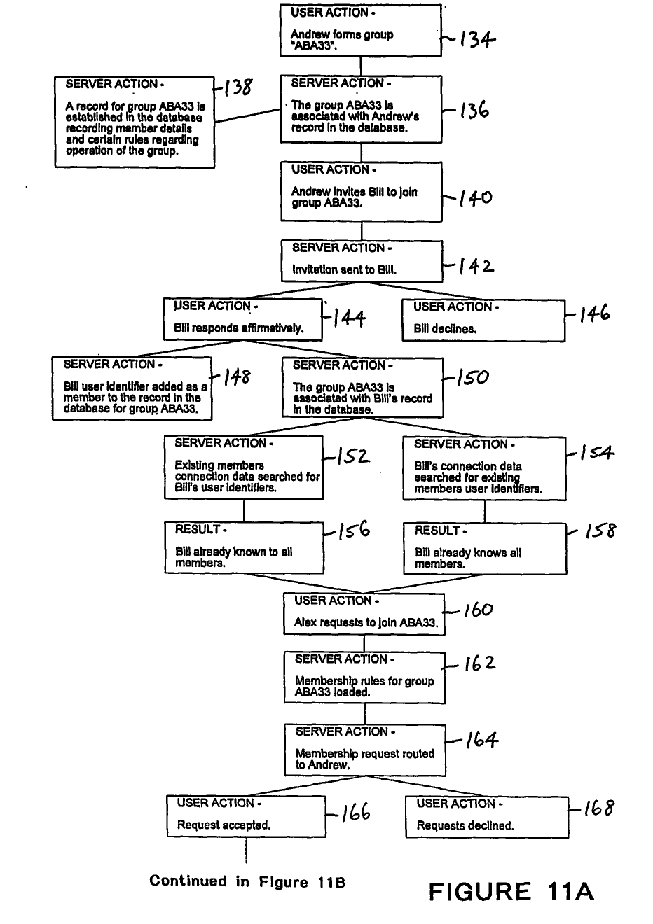

The process for determining if there is an indirect connection between users may be illustrated by reference to FIG. 10. Andrew can determine if there is an indirect connection between himself and Fred by using the SDMS 128 to search the connection data of all users comprised in Andrews connection data and inbound connection set to see if any of them has Fred's user identifier 130. If any such users do then it can be presumed that they know Fred and would be able to tell Andrew a little more about Fred and if appropriate arrange for a meeting or otherwise provide an introduction of Andrew to Fred. In the present example it can be seen that Andrew's search would be successful and that the system would advise him 132 that Bill has Fred's contact details in his address book.

A further service relates to the formation of groups by users. Users of a network system may assign themselves or agree to be assigned to one or more groups. Such groups may represent clubs, families, workplaces or any other logical grouping of users.

Upon its formation or subsequently a group may be configured to operate under certain rules such as which members are permitted to invite others to join the group, who is required to approve new members etc.

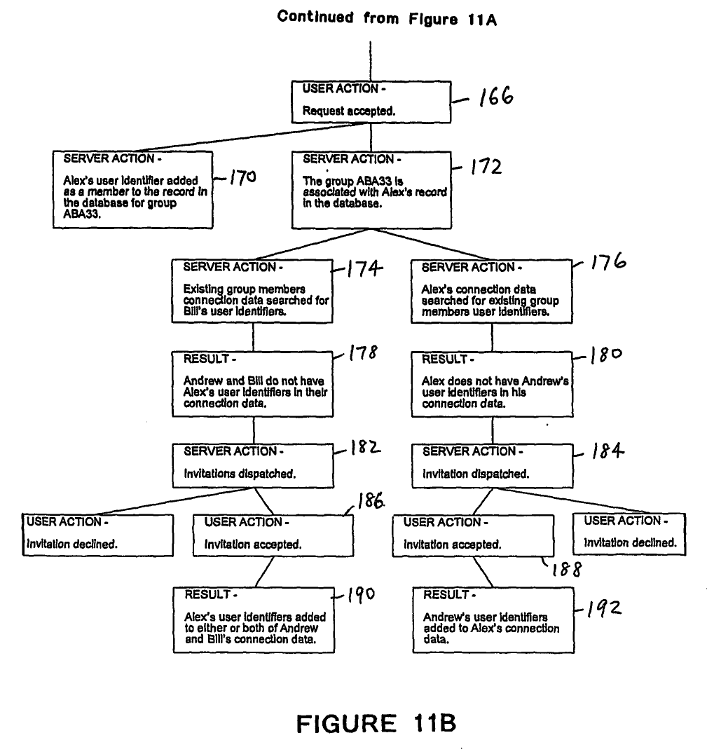

The process for the formation and operation of groups may be illustrated by reference to FIGS. 11A and 11B. FIG. 11B is a continuation of FIG. 11A, the diagram having been separated into two parts for ease of illustration. Andrew, Bill and Alex may belong to a chess club and wish to form a group within the SDMS. Andrew takes the initiative and uses his NAD or other communications means to instruct the SDMS to form a group, with a unique name say “ABA33” 134. As the founder of the group Andrew is automatically a member 136, 138.

Andrew has Bill's user identifier in his connection data and so can invite him to join the group 140. Andrew could initiate such an invitation using his NAD or any other means of accessing the SDMS, including for example, a web browser. The invitation is issued to Bill 142 using any communications means available to the SDMS and which Bill is capable of receiving. Preferably such invitations are provided to Bill by a communications means compatible with Bill's NAD. Should Bill respond affirmatively 144 to the invitation then his user identifier will be added to the record for group 148 and the group will be associated with his record in the database 150.

Upon joining the group the system will compare Bill's connection data with the user identifiers for the members of group ABA33 154 and if there are any group members that are not included in Bill's connection data the SDMS will generate a number invitation to Bill asking if he would like such members details added to his connection data (in the manner previously discussed). In the present case the only members of group ABA33 are Andrew and Bill and Bill already has Andrew's user identifier in his connection data so the system will not issue any number invitation's to Bill 158. Whenever a new member joins the group the SDMS will also search the connection data of existing members to determine if any of the existing members do not already have the new member's user identifiers in their connection data. In the present case Andrew is the only existing member and he already has Bill's user identifiers and so no number invitations will be issued to existing users 158.

Alex may wish to join the group, and not having already been invited, may use his NAD or other communications means to contact the SDMS and request to join the group 160. Upon receipt of a membership request the SDMS will load the rules for the group 162 to determine how such membership requests should be addressed. Alex's request may be routed to Andrew (as the group's founder) or to other members of the group depending on how the group was set up. In the present case the rule for the group specifies that all membership requests should be routed to Andrew 164.

If the member(s) responsible for approving new members, in this case Andrew, approve Alex's request to join the group 166 then Alex's user identifier will be added to the record for group 170 and the group will be associated with his record in the database 172.

In a similar fashion to when Bill joined the group, upon Alex's acceptance into the group the SDMS will search Alex's connection data for the user identifiers of the existing group members 176 and search the existing group members connection data for Alex's user identifiers 174. In the present case it will be seen that Alex already has Bill's user identifier in his connection data but does not have Andrews 180. Accordingly the SDMS will generate a number invitation 184 asking whether or not Alex would like to have Andrew's user identifier added to his connection data and if Alex responds affirmatively 188 then Andrew's user identifier will be inserted into the connection data on Alex's NAD 192. Correspondingly, the search of existing user's connection data will have determined that neither Andrew or Bill have Alex's connection data 178 and so both will receive number invitations 182 asking whether or not they would like to have Alex's number inserted into their connection data. If either or both of them respond affirmatively to this invitation 186 then Alex's user identifiers will be added to their connection data 190.

Continuing with the example of group ABA33, it may be that at some later stage Bill changes his user identifier within the network system. This may occur under numerous circumstances, such as where a user upgrades a service provider plan pursuant to which they access the network. In the present example, the SDMS would notify all those that have a connection with Bill of the change in Bill's user identifier (in the manner previously discussed and illustrated by FIG. 5), including those that obtained Bill's user identifier via their membership of a group.

In due course additional members may join group ABA33 and eventually members may also wish to leave the group. If Bill decides to leave the group then he may use his NAD or other communications means to contact the SDMS and request that he be removed from the group. In response to this request the SDMS would generate a removal notice to each member of the group that has Bill's user identifier in their connection data notifying them of Bill's removal from the group and asking if the member would like Bill's user identifier removed from their connection data. During his time with the group Bill may have formed relationships that extend beyond the immediate business of the group and so upon his removal from the group those with which he has formed a relationship, such as Alex for example, may decline to have Bill's user identifier removed from their connection data while others in the group, such as Andrew for example, with whom Bill is unlikely to have ongoing contact outside the context of the group, may agree to the removal of Bill's user identifier from their connection data. Correspondingly, upon Bill's withdrawal from the group the system will ask Bill if he would like to remove some or all of the remaining group member's user identifiers from his connection data.

In a further application of the present system, if a user leaves the network system for any reason the operator of that system may remove their user identifier from the connection data of other users of the network system. Referring again to FIG. 3 and the preceding example, if subsequent to leaving group ABA33 Bill was to leave the network system then a removal notification would be generated and sent to each user in the network system with Bill's user identifier in their connection data. As noted in the preceding paragraph, Alex declined to remove Bill from his connection data when Bill left group ABA33 so Bill's user identifier would still be in Alex's connection data and accordingly Alex would be one of the users that receive a removal notice. If Alex has an application on his NAD then he will be asked if he would like Bill's user identifier removed from his connection data and if he agrees then Bill's user identifier will be removed automatically. If Alex does not have an application operating on his NAD then he will be able to read the notification and manually remove Bill's user identifier from his connection data.

In the case where a predetermined user has left the given network system and moved to a different network system that has an SDMS interlinked with the SDMS of the given network system (either directly or through an inter-operator exchange) then it may be that a removal notification (as specified in the preceding paragraph) is not issued by the SDMS of the given network system as the SDMS of the new network system may instead issue a change in user identifier notification to all users in both network systems that have the predetermined user's user identifier in their connection data. Continuing with the example in the preceding paragraph, if at the same time as leaving the network system Bill also moved to an interlinked network system, then upon joining the interlinked network system a notification would be generated and sent by the SDMS in the interlinked network system to all users of both network systems with Bill's previous user identifier in their connection data informing such users of Bill's new user identifier and providing them with the opportunity to update their record of Bill's user identifier in their connection data. In the example of the preceding paragraph, Alex would be one of the user's receiving a notification of Bill's new user identifier.

The present invention may also be interconnected with alternative means of obtaining user identifiers. Examples of such alternative means include telephone directory services that a user can call for another user's telephone number and similarly equivalent Internet based directory services. An additional example could also be any web page with a user identifier on it where the web page is also linked to the user's SDMS. In addition to providing a user with a predetermined user's user identifier such alternative means may also provide the user with the option of adding the predetermined user's user identifier to the user's connection data. For example if a new user, Tom, required Alex's telephone number then Tom may call his phone company's directory service. Typically the calling parties telephone number is passed to the directory service and so once the directory service provides Tom with Alex's number it may also give Tom the option of adding Alex's number directly to his connection data. This option will be available where Tom's phone number is passed to the directory service as part of the ordinary operation of a telephone network provided the directory service is linked with an SDMS and Tom has subscribed to the services of that SDMS or of an SDMS interconnected with that SDMS. If Tom accepts the option of having Alex's user identifier added to his connection data then the directory service will communicate Tom's phone number and Alex's user identifier to the SDMS which will then communicate the information to Tom's NAD.

Generally, data from alternative means of obtaining user identifiers will be able to be added to users' connection data whenever there is a means of uniquely identifying the user making the enquiry of the alternative means and there is a direct or indirect link between the alternative means and an SDMS to which the enquiring user belongs.

In summary, the invention advantageously allows relationships between users of a network system to be determined, created and maintained. This facilitates personal and business relationships and increases appropriate use of the network.

Where in the foregoing description reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention.

1. A method for determining one or more relationships between a plurality of users of a network system, the method including the steps of:
a) populating a database with a unique network user identifier for each of the plurality of users,
b) selecting a user and further populating the database with connection data for the selected user from a network access device associated with the selected user to provide unique network user identifiers of users known to the selected user,
c) repeating step b) for the remainder of the plurality of users,
d) for a predetermined user, searching each of the plurality of user's connection data in the database for the predetermined user's unique network user identifier to identify all users that have the predetermined user's unique network user identifier in their connection data,
e) storing the network user identifiers of the users located by the search of step d), to provide set of data for the predetermined user representative of one or more other user's relationship with the predetermined user, and
f) providing data from the data setoff step e) to a network access device associated with the predetermined user.

2. (canceled)

3. A method as claimed in claim 1 where step d) includes searching each user's connection data in the database for any additional network user identifiers for the predetermined user.

4. (canceled)

5. A method as claimed in claim 3 where step f) includes comparing the data set of step e) with the connection data for the predetermined user, and providing to a network access device associated with the predetermined user the network user identifier of any users comprised in the data set of step e) which do not comprise part of the predetermined user's connection data.

6. A method as claimed in claim 5 including the step of providing the predetermined user with the opportunity to include the network user identifiers of any users comprised in the data set of step e) which do not comprise part of the predetermined user's connection data in the predetermined user's connection data.

7. A method as claimed in claim 1 where step f) includes comparing the connection data of the predetermined user with the data set of step e), and providing to a network access device associated with the predetermined user the network user identifier of any users comprised in the connection data which do not comprise part of the data set of step e).

8. A method as claimed in claim 7 including the step of using the network user identifiers of any users comprised in the connection data which are not present in the data set of step e) to contact users whose network user identifiers are in the predetermined user's connection data but not in the data set of step e) to invite those users to include the predetermined user's network user identifier in their connection data.

9. A method as claimed in claim 1 including the step of using the data set of step e) to provide an indication of the popularity of a user of the network system.

10. A method as claimed in claim 1 including the step of determining whether a network user identifier for a predetermined user has changed, and if a change is detected, performing steps d) and e) and using the user identifiers comprised in the data set of step e) to contact users who have the predetermined user's network user identifier and inform those users of the change in the predetermined user's network user identifier.

11. A method as claimed in claim 1 including the steps of further populating the database with a user preferred identifier by which a predetermined user prefers to be identified and associating the user preferred identifier with the predetermined user's unique network user identifier prior to performing step d).

12. A method as claimed in claim 11 where step f) includes sending an invitation to a network access device associated with each of the users that have the predetermined user's unique network user identifier in their connection data to associate the predetermined user's user preferred identifier with the predetermined user's unique network user identifier in their connection data.

13. A method as claimed in claim 1 including the step of further populating the database with one or more characteristics of each user prior to step d), searching the record in the database for each user in the data set of step e) for at least one of the characteristics, and providing the network user identifiers of those users having the at lest one characteristics to a network access device associated with the predetermined user.

14. A method as claimed in claim 13 including the step of searching the record in the database of each user comprised in the connection data of each user comprised in the predetermined users connection data and searching the record in the database and connection data of each user comprised in the data set of step e) and each user comprised in the connection data of each user comprised in the data set of step e) for the at least one.

15. (canceled)

16. (canceled)

17. (canceled)

18. (canceled)

19. (canceled)

20. (canceled)

21. (canceled)

22. (canceled)

23. (canceled)

24. A method as claimed in claim 1 including the steps of:
further populating the database with additional user identifiers of each user, such user identifiers relating to the applicable network system or an other network system;
enabling other users of the network system with one of a predetermined user's user identifiers to request other user identifiers from the system for the predetermined user; and
providing such other users with a predetermined user's additional user identifiers.

25. A method as claimed in claim 1 including the step of allowing a predetermined user to mark some or all of their connection data as not accessible to other users of the system to the effect that it would appear to other users of the system that the marked data is not included in the predetermined user's connection data.

26. A method as claimed in claim 1 including the steps of:
providing a plurality of databases populated with connection data and connecting the plurality of databases to a centralised database;
populating the centralised database with some or all of the connection data from the connected databases;
maintaining synchronisation between the connection data in the centralised database and the connected databases; and
providing a predetermined user's connection data to the predetermined user through one of the connected databases.

27. A method as claimed in claim 1 including the steps of:
providing a plurality of databases populated with connection data and connecting the plurality of databases directly with each other;
transmitting processing requests from either a predetermined user of a connected database or a process operating on the connected database itself, to the other connected databases;
processing requests received from other connected databases;
transmitting the results of any processing requests to the originating connected database; and
providing the aggregate results received from all connected databases to the predetermined user or process operating on the originating connected database.

28. A method as claimed in claim 1 including the steps of:
providing a plurality of databases populated with connection data and connecting the plurality of databases to a central inter-operator exchange;
transmitting processing requests from either a predetermined user of a connected database or a process operating on the connected database itself to the central inter-operator exchange;
transmitting such processing requests from the central inter-operator exchange to the connected databases;
processing requests received from the central inter-operator exchange;
transmitting the results of any processing requests received from the central inter-operator exchange to the central inter-operator exchange;
transmitting results received from connected databases either individually or in aggregate from the central inter-operator exchange to the originating connected database; and
providing the aggregate results received from the central inter-operator exchange to the predetermined user or process operating on the originating connected database.

29. A method as claimed in claim 1 including the steps of:
providing a plurality of databases populated with connection data and connecting the plurality of databases to a central data and processing centre;
populating the central database and processing centre with the connection data from the connected databases;
maintaining synchronisation between the connection data in the central database and processing centre and the connected databases;
transmitting processing requests from a predetermined user of a connected database or a process operating on the connected database itself to the central database and processing centre;
processing requests received from the connected databases;
transmitting the results of any processing requests to the originating connected database; and
providing the results to the predetermined user or process operating on the originating connected database.

30. A computerized apparatus comprising,
a) means for populating a database with a unique network user identifier for each of the plurality of users,
b) means for selecting a user and further populating the database with connection data for the selected user from a network access device associated with the selected user to provide unique network user identifiers of users known to the selected user,
c) means for repeating step b) for the remainder of the plurality of users,
d) means for a predetermined user, searching each of the plurality of user's connection data in the database for the predetermined user's unique network user identifier to identify all users that have the predetermined user's unique network user identifier in their connection data,
e) means for storing the network user identifiers of the users located by the search of step d), to provide set of data for the predetermined user representative of one or more other user's relationship with the predetermined user, and
f) means for providing data from the data setoff step e) to a network access device associated with the predetermined user.

31. Apparatus for determining one or more relationships between a plurality of users of a network system, the apparatus including:
a database populated with a unique network user identifier for each of the plurality of users and with connection data for each such user, the connection data being obtained from a network access device associated with each such user,
a processor adapted to search each user's connection data in the database for a predetermined user's unique network user identifier to identify all users that have the predetermined user's unique network user identifier in their connection data,
a memory device to store the user identifiers located by the search to provide a data set for the predetermined user representative of one or more other user's relationship with the predetermined user, and wherein the processor is further adapted to provide the data set to a network access device associated with the predetermined user.

32. A method as claimed in claim 9 including the step of providing the indication of popularity to an operator of a separate network system which is interconnected to the network system.

33. A method as claimed in claim 1 including the step of determining whether a network user identifier for a predetermined user has changed, and if a change is detected, including the new network user identifier in the connection data on the database prior to performing step d).

34. A method as claimed in claim 1 including the step of determining whether a network user identifier for a predetermined user has changed, and if a change is detected, performing steps d) and e) and using the user identifiers comprised in the data set of step e) to send an instruction to a network access device associated with each of the users who have the predetermined user's network user identifier to update the predetermined user's network identifier in their connection data.

35. A method as claimed in claim 11 where step f) includes sending an instruction to a network access device associated with each of the users who have the predetermined user's unique network user identifier in their connection data to associate the predetermined user's network user identifier with the predetermined user's user preferred identifier in their connection data.

36. A method as claimed in claim 13 including searching for a given user identifier or a user preferred identifier.

37. A method as claimed in claim 36 including searching for a given user identifier or a user preferred identifier.

38. A method as claimed in claim 14 including searching for a given user identifier or a user preferred identifier.

39. A method as claimed in claim 13 including the step of searching the record in the database of each user comprised in the connection data of the predetermined user for the at least one characteristics.

40. A method as claimed in claim 1 including the step of synchronizing the connection data stored on the database with the connection data on users' network access devices.

41. A method as claimed in claim 1 including receiving new connection data from a user's network access device which includes changes from the connection data for that user present on the database, and including the new connection data in that user's connection data on the database prior to step d).

42. A method as claimed in claim 1 wherein the plurality of users comprise a subset of users of the network system.

43. A method as claimed in claim 42 including the step of detecting any users added to the subset and providing the other users in the subset with the unique user identifier of the added user.

44. A method as claimed in claim 42 including the step of detecting any users removed from the subset and notifying any other member of the subset that has the removed user's unique identifier in their connection data.
